(19) United States
(12) Patent Application Publication
(10) Pub. No.: US 2026/0259474 A1
(43) Pub. Date: Sep. 3, 2026

(54) LENS DRIVING DEVICE, CAMERA DEVICE AND OPTICAL DEVICE

(71) Applicant: LG INNOTEK CO., LTD., Seoul (KR)

(72) Inventors: Yun Ho NOH, Seoul (KR); Hyeon Jun JANG, Seoul (KR)

(73) Assignee: LG INNOTEK CO., LTD., Seoul (KR)

(21) Appl. No.: 19/163,933

(22) PCT Filed: Mar. 18, 2024
(86) PCT No.: PCT/KR2024/003375

§ 371 Date: Sep. 10, 2025

(30) Foreign Application Priority Data
Apr. 3, 2023 (KR) 10-2023-0043692

(51) Int. Cl. G03B 5/04; G03B 13/36

(52) U.S. Cl. CPC G03B 5/04; G03B 13/36; G03B 2205/0015

(57) ABSTRACT

The present disclosure relates to a lens driving device comprising: a holder member; a first moving part which is disposed on the holder member and which moves in a first direction that is perpendicular to an optical axis with respect to the holder member; a second moving part which is disposed on the first moving part, and which moves in a second direction that is perpendicular to the optical axis and intersects the first direction; a cover disposed on the second moving part and coupled to the holder member; a first ball disposed between the holder member and the first moving part; a second ball disposed between the first moving part and the second moving part; and a pressing part disposed between the second moving part and the cover, wherein the pressing part includes an elastic member and presses the first ball and/or the second ball.

### TECHNICAL FIELDS

The teachings in accordance with exemplary and non-limiting embodiments of the present disclosure relate generally to a lens driving device, a camera device, and an optical instrument.

### BACKGROUND ARTS

A camera device is a device that captures images or videos of subjects and is installed in optical devices such as smartphones, drones, and vehicles.

The camera device is equipped with optical image stabilization function to prevent blurring caused by handshakes.

The optical image stabilization function can be achieved through the electromagnetic interaction between magnets and coils. In this case, guide balls may be provided to guide the movement of the moving part relative to the fixed part, requiring a structure where the guide balls are sandwiched between the fixed part and the moving part.

Conventionally, the magnetic force between a magnet and a yoke has been used to clamp the guide ball.

However, in this case, a return force acts to return the moving part and the fixed part to a position where the magnetic force between the magnet and the yoke is the strongest, resulting in an increase in the current consumption during operation.
(Patent Document 1) KR 10-2015-0118005 A

### DETAILED DESCRIPTION OF DISCLOSURE

### Technical Subjects

The present embodiment aims to provide a lens driving device that minimizes the current consumption during Optical image stabilization (IS) drive (or operation). More specifically, the present embodiment aims to provide a lens driving device that does not have a return force between the moving part and the fixed part during OIS (optical image stabilization) drive.

Furthermore, the present embodiment aims to provide a lens driving device that minimizes current consumption during autofocus drive. More specifically, the present embodiment aims to provide a lens driving device that eliminates return force between the moving part and the fixed part during autofocus drive.

### Technical Solution

A lens driving device according to an embodiment of the present disclosure may comprise: a holder member; a first moving part which is disposed on the holder member and which moves in a first direction that is perpendicular to an optical axis with respect to the holder member; a second moving part which is disposed on the first moving part, and which moves in a second direction that is perpendicular to the optical axis and intersects the first direction; a cover disposed on the second moving part and coupled to the holder member; a first ball disposed between the holder member and the first moving part; a second ball disposed between the first moving part and the second moving part; and a pressing part disposed between the second moving part and the cover, wherein the pressing part comprises an elastic member and presses at least one of the first ball and the second ball.

Preferably, but not necessarily, the pressing part may comprise a third ball disposed between the second moving part and the elastic member, and a plate member disposed between the third ball and the elastic member.

Preferably, but not necessarily, the pressing part may press the second moving part toward the holder member in the direction facing downward of the optical axis..

Preferably, but not necessarily, the elastic member may comprise a first portion and a second portion disposed on the cover, and a third portion connecting the first portion and the second portion and disposed on the plate member.

Preferably, but not necessarily, the lens driving device may further comprise a first driving part for moving the first moving part in the first direction relative to the holder member, and a second driving part for moving the second moving part in the second direction relative to the holder member.

Preferably, but not necessarily, at least one of the holder member and the first moving part may comprise a first groove disposed in the first direction, the first ball is disposed in a first groove, and at least one of the first moving part and the second moving part may comprise a second groove disposed in the second direction, and the second ball may be disposed in a second groove.

Preferably, but not necessarily, the lens driving device may further comprise a first substrate disposed on the holder member, wherein the first driving part may comprise a first coil disposed on the first substrate and a first magnet disposed on the second moving part and interacting with the first coil, and the second driving part may comprise a second coil disposed on the first substrate and a second magnet disposed on the second moving part and interacting with the second coil.

Preferably, but not necessarily, the lens driving device may further comprise: a base and a third driving part that moves the holder member in the optical axis direction relative to the base.

Preferably, but not necessarily, the lens driving device may further comprise a second substrate disposed on the base, wherein the third driving part may comprise a third coil disposed on the second substrate and a third magnet disposed on the holder member and interacting with the third coil.

A lens driving device according to an embodiment of present disclosure may comprise: a base; an AF carrier disposed on the base; an OIS carrier disposed on the AF carrier; a first ball disposed between the AF carrier and a lower surface of the OIS carrier; and a pressing part disposed on the OIS carrier and comprising an elastic member, wherein the pressing part is capable of pressing the first ball against the AF carrier or the OIS carrier so as to be in close contact therewith.

Preferably, but not necessarily, the pressing part may comprise a second ball disposed on the OIS carrier and a plate member disposed between a second ball and the elastic member.

Preferably, but not necessarily, the second ball may be disposed on the upper surface opposite the upper surface of the OIS carrier.

Preferably, but not necessarily, the lens driving device may further comprise: a first coil and a first magnet for moving the AF carrier in the optical axis direction relative to the base, and a second coil and a second magnet for moving the OIS carrier in a direction perpendicular to the optical axis direction relative to the AF carrier.

Preferably, but not necessarily, the lens driving device may further comprise a guide member disposed between the AF carrier and the OIS carrier, and the first ball may comprise a first-first ball disposed between the AF carrier and the guide member, and a first-second ball disposed between the guide member and the OIS carrier.

A lens driving device according to an embodiment of the present disclosure may comprise: a holder member; a moving part disposed on the holder member and movable in a direction perpendicular to the optical axis relative to the holder member; a cover disposed on the moving part and coupled to the holder member; a ball disposed between the holder member and the moving part; and a pressing part disposed between the moving part and the cover, wherein the pressing part may comprise an elastic member and is capable of pressing the ball.

A lens driving device according to an embodiment of the present disclosure may comprise: a first member comprising an upper plate and a lower plate; a second member disposed between the upper plate and the lower plate of the first member; a first driving unit for moving the second member in a direction perpendicular to the optical axis with respect to the first member; a first ball disposed between the lower plate of the first member and the second member; a second ball disposed between the second member and the upper plate of the first member; and an elastic member disposed between the second ball and the upper plate of the first member, wherein the elastic member is capable of pressing the second ball in a direction in which the upper plate of the first member faces the second member.

Preferably but not necessarily, the lens driving device may further comprise a plate member disposed between the elastic member and the second ball.

Preferably but not necessarily, the elastic member may comprise a first portion and a second portion disposed on the upper plate of the first member, and a third portion connecting the first portion and the second portion and disposed on the plate member.

Preferably but not necessarily, the second member may press the first ball toward the lower plate side of the first member by a pressing force of the elastic member.

Preferably but not necessarily, the lens driving device may further comprise a guide member disposed between the lower plate of the first member and the second member, wherein the first ball may comprise a first-first ball disposed between the lower plate of the first member and the guide member, and a first-second ball disposed between the guide member and the second member.

Preferably but not necessarily, the first driving part may comprise a first-first driving part that moves the second member in a first direction perpendicular to the optical axis relative to the first member, a first-second driving part that moves the second member in a second direction perpendicular to both the optical axis and the first direction relative to the first member, wherein one of the first-first ball and the first-second ball may be guided to move in the first direction and the other may be guided to move in the second direction.

Preferably but not necessarily, at least one of the lower plate of the first member and the guide member may comprise a first groove disposed in the first direction, and the first-first ball may be disposed in the first groove, at least one of the guide member and the second member may comprise a second groove disposed in the second direction, and the first-second ball may be disposed in the second groove.

Preferably but not necessarily, the lens driving device may further comprise a first substrate disposed on the first member, wherein the first-first driving part may comprise a first-first coil disposed on the first substrate, a first-first magnet disposed on the second member and interacting with the first-first coil, and the first-second driving part may comprise a first-second coil disposed on the first substrate and a first-second magnet disposed on the second member and interacting with the first-second coil.

Preferably but not necessarily, the lens driving device may further comprise: a base and a second driving part that moves the first member in the optical axis direction relative to the base.

Preferably but not necessarily, the lens driving device may further comprise a second substrate disposed on the base, wherein the second driving part may comprise a second coil disposed on the second substrate and a second magnet disposed on the first member and interacting with the second coil.

Preferably but not necessarily, the first member may comprise a holder member comprising the lower plate and a cover comprising the upper plate and coupled to the holder member.

Preferably but not necessarily, the first member may comprise a base comprising the lower plate and a cover comprising the upper plate and coupled to the base.

A lens driving device according to an embodiment of the present disclosure may comprise: a base; an AF carrier disposed on the base; an OIS carrier disposed on the AF carrier; a first coil and a first magnet for moving the AF carrier in the optical axis direction relative to the base; a second coil and a second magnet for moving the OIS carrier in a direction perpendicular to the optical axis direction relative to the AF carrier; a first ball disposed between the AF carrier and the OIS carrier; a second ball disposed on the OIS carrier; and an elastic member for pressing the second ball, wherein the first ball is disposed on a lower surface of the OIS carrier, the second ball is disposed on an upper surface opposite to the lower surface of the OIS carrier, and the elastic member is capable of pressing the second ball so as to be in close contact with the AF carrier.

A camera module according to an embodiment of the present disclosure may comprise: a printed circuit board; an image sensor disposed on the printed circuit board; a lens driving device disposed on the printed circuit board; and a lens coupled to the lens driving device.

An optical apparatus according to an embodiment of the present disclosure may comprise: a main body; a camera device disposed on the main body; and a display disposed on the main body for outputting one or more of the images and videos captured by the camera device.

### Advantageous Effects

Through these embodiments, the current consumption during optical image stabilization drive (or operation) can be minimized. More specifically, in the embodiments, there is no return force between the moving part and the fixed part during optical image stabilization drive, thereby minimizing the current consumption during optical image stabilization drive.

Furthermore, through these embodiments, the current consumption during auto focus drive can be minimized. More specifically, in these embodiments, there is no return force between the moving part and the fixed part during auto focus drive, thereby minimizing the current consumption during auto focus drive. In other words, in these embodiments, the current consumption can be minimized because the yoke, which is subject to magnet and attraction, is omitted.

### BRIEF DESCRIPTION OF DRAWINGS

FIG. 1 is a perspective view of a lens driving device according to an embodiment of the present disclosure.

FIG. 2 is a cross-sectional view of the lens driving device shown in FIG. 1, taken along A-A line.

FIG. 3 is a cross-sectional view of the lens driving device shown in FIG. 1, taken along B-B line.

FIG. 4 is a cross-sectional view of a lens driving device, cut perpendicular to an optical axis and viewed from above, according to an embodiment of the present disclosure.

FIG. 5a is an exploded perspective view of a lens driving device according to an embodiment of the present disclosure.

FIG. 5b is an exploded perspective view of the lens driving device shown in FIG. 5a, viewed from a different direction.

FIG. 6 is a perspective view of a lens driving device according to an embodiment of the present disclosure, with a cover omitted.

FIG. 7 is a perspective view showing a configuration related to a fixed part of a lens driving device according to an embodiment of the present disclosure.

FIG. 8 is a perspective view showing a configuration related to a moving part of a lens driving device according to an embodiment of the present disclosure.

FIG. 9 is a perspective view showing a configuration related to an OIS moving part of a lens driving device according to an embodiment of the present disclosure.

FIG. 10 is a plan view of a lens driving device according to an embodiment of the present disclosure.

FIG. 11 is a plan view of FIG. 10 with a cover removed.

FIG. 12 is a plan view of FIG. 11 with a cover removed.

FIG. 13 is a plan view of FIG. 12 with a plate member removed and a partially enlarged view.

FIG. 14 is a plan view of FIG. 13 with an OIS carrier removed and a partially enlarged view.

FIG. 15 is a plan view of FIG. 14 with a guide member removed and a partially enlarged view.

FIG. 16 is an exploded perspective view showing a cover, an OIS ball pressing member, and an OIS carrier.

FIG. 17 is an exploded perspective view showing an OIS carrier, an OIS-y guide ball, and a guide member.

FIG. 18 is an exploded perspective view showing a guide member, an OIS-x guide ball, and a holder member.

FIG. 19 is a bottom exploded perspective view of FIG. 16 from a different direction.

FIG. 20 is a bottom exploded perspective view of FIG. 17 from a different direction.

FIG. 21 is a bottom exploded perspective view of FIG. 18 from a different direction.

FIG. 22 is a perspective view showing a configuration related to an OIS ball pressing member.

FIG. 23a is a cross-sectional view showing a configuration related to an OIS ball pressing member and an OIS guide ball.

FIG. 23b is an enlarged view of a portion of FIG. 23a.

FIG. 24 is a cross-sectional view of a configuration related to an OIS ball pressing member and an OIS guide ball, viewed by cutting in a direction perpendicular to FIG. 23a.

FIG. 25 is a plan view showing a structure related to an AF guide ball according to an embodiment of the present disclosure.

FIG. 26 is a perspective view showing a configuration related to an AF guide ball of a lens driving device according to an embodiment of the present disclosure.

FIG. 27 is a perspective view showing a structured related to an AF guide ball of a base of a lens driving device according to an embodiment of the present disclosure.

FIG. 28 is a perspective view showing a state in which a ball, a plate member, an elastic member and reinforcing member are disposed in FIG. 27.

FIG. 29 is a perspective view of FIG. 28 viewed from a different direction.

FIG. 30 is a perspective view showing an AF moving part and an AF guide ball of a lens driving device according to an embodiment of the present disclosure.

FIGS. 31 to 33 are drawings showing an autofocus drive of a lens driving device according to an embodiment of the present disclosure, where FIG. 31 is a cross-sectional view showing the appearance of a moving part in an initial state where no current is applied to an AF coil, FIG. 32 is a cross-sectional view showing the appearance of the moving part moved upward in the optical axis direction when a forward current is applied to the AF coil, and FIG. 33 is a cross-sectional view showing the moving part moving downward along the optical axis when a reverse current is applied to the AF coil.

FIGS. 34 to 36 are drawings showing a optical image stabilization drive of a lens driving device according to an embodiment of the present disclosure, where FIG. 34 is a cross-sectional view showing the appearance of an OIS moving part in an initial state where no current is applied to an appearance of an OIS moving part in an initial state where no current is applied to an OIS-x coil and an OIS-y coil, FIG. 35 is a cross-sectional view showing the appearance of an OIS moving part moved in the x-axis direction perpendicular to the optical axis when current is applied to the OIS-x coil, and FIG. 36 is a cross-sectional view showing an OIS moving part moved in the y-axis direction perpendicular to both the optical axis and the x-axis when current is applied to the OIS-y coil.

FIG. 37 is an exploded perspective view of a camera device according to an embodiment of the present disclosure.

FIG. 38 is a perspective view of an optical instrument according to an embodiment of the present disclosure.

FIG. 39 is a perspective view of an optical instrument according to a modified example.

### BEST MODEL

Hereinafter, exemplary embodiments of the present disclosure will be described in detail with reference to the accompanying drawings.

However, the present disclosure is not limited to the given exemplary embodiments described, but may be implemented in a variety of different forms, and one or more of components among the exemplary embodiments may be optionally combined or substituted between embodiments within the scope of the present disclosure.

Furthermore, terms (comprising technical and scientific terms) used in the embodiments of the present disclosure, unless expressly specifically defined and described, are to be interpreted in the sense in which they would be understood by a person of ordinary skill in the art to which the present disclosure belongs, and commonly used terms, such as dictionary-defined terms, are to be interpreted in light of their contextual meaning in the relevant art.

Furthermore, the terms used in the embodiments of the disclosure are intended to describe the embodiments and are not intended to limit the disclosure.

In this specification, the singular may comprise the plural unless the context otherwise requires, and references to “at least one (or more) of A and (or) B and C” may comprise one or more of any combination of A, B, and C that may be assembled.

In addition, the terms first, second, A, B, (a), (b), and the like may be used to describe components of embodiments of the disclosure. Such terms are intended only to distinguish one component from another, and are not intended to limit the nature or sequence or order of such components by such terms.

Furthermore, when a component is described as “connected,” “coupled,” or “attached” to another component, it can comprise cases where the component is “connected,” “coupled,” or “attached” to the other component directly, as well as cases where the component is “connected,” “coupled,” or “attached” to another component that is between the component and the other component.

Still furthermore, when described as being formed or disposed “above” or “below” each component, “above” or “below” comprises not only when two components are in direct contact with each other, but also when one or more other components are formed or disposed between the two components. Furthermore, when expressed as “above” or “below”, it may comprise the meaning of upward as well as downward with respect to a single component.

The term ‘optical axis (Optical Axis, refer to OA in FIG. 31)’ used herein refers to the optical axis direction of a lens and/or an image sensor coupled to a lens driving device.

The term ‘vertical direction’ used herein may be parallel to or the same as the optical axis direction. The vertical direction may correspond to the ‘z-axis direction.’ The term ‘horizontal direction’ used herein may be a direction perpendicular to the vertical direction. That is, the horizontal direction may be a direction perpendicular to the optical axis. Therefore, the horizontal direction may comprise the ‘x-axis direction’ and the ‘y-axis direction.’

Herein, one of the ‘x-axis direction’ and the ‘y-axis direction’ may be referred to as a ‘first direction,’ and the other may be referred to as a ‘second direction.’

The term ‘auto focus (AF) function’ used hereinafter refers to a function of automatically adjusting a focus relative to a subject by moving a lens to an optical axis direction to adjust a distance with an image sensor according to a distance to the subject whereby a clear image of the subject can be obtained on the image sensor.

Additionally, ‘auto focus feedback (CLAF, closed-loop auto focus) control’ is defined as a function of real-time control of a lens position by detecting a distance between the image sensor and the lens to improve the accuracy of focus adjustment.

The term ‘image stabilization (OIS, optical image stabilization)’ used herein refers to a function that prevents images or videos from blurring due to hand shake by moving or tilting the lens in a direction perpendicular to the optical axis to counteract hand shake. Additionally, ‘image stabilization feedback (CLAF, closed-loop auto focus) control’ is defined as the process of detecting the position of the lens relative to the image sensor and providing real-time feedback (feedback, feedback control) to adjust the lens position in order to improve the accuracy of image stabilization.

Hereinafter, one of the ‘AF moving part (200)’ and ‘OIS moving part (300)’ may be referred to as the ‘first moving part’ and the other as the ‘second moving part.’

Additionally, in the following description, one of an ‘OIS carrier (310)’ and a ‘guide member (350)’ may be referred to as a ‘first moving part,’ and the other as a ‘second moving part.’

Hereinafter, one of the ‘AF driving part (400)’ and ‘OIS driving part’ may be referred to as a ‘first driving part,’ and the other as a ‘second driving part.’

Hereinafter, one of the ‘AF driving part (400)’, ‘OIS-x driving part (500)’ and ‘OIS-y driving part (600)’ may be referred to as a ‘first driving part’, another as a ‘second driving part’ and the other as a ‘third driving part’. Alternatively, when the ‘OIS driving part’ is referred to as the ‘first driving part,’ one of the ‘OIS-x driving part (500)’ and ‘OIS-y driving part (600)’ may be referred to as a ‘first-first driving part,’ and the other as a ‘first-second driving part.’

Hereinafter, one of the ‘AF magnet (410)’, ‘OIS-x magnet (510)’, and ‘OIS-y magnet (610)’ may be referred to as a ‘first magnet’, another as a ‘second magnet’, and the remaining one as a ‘third magnet’. Alternatively, when the ‘OIS magnet’ is referred to as the ‘first magnet,’ one of the ‘OIS-x magnet (510)’ and ‘OIS-y magnet (610)’ may be referred to as a ‘first-first magnet,’ and the other as a ‘first-second magnet.’

Hereinafter, one of the ‘AF coil (420)’, ‘OIS-x coil (520)’ and ‘OIS-y coil (620)’ may be referred to as a ‘first coil’, another as a ‘second coil’ and yet another as a ‘third coil’. Alternatively, when ‘OIS coil’ is referred to as ‘first coil,’ one of ‘OIS-x coil (520)’ and ‘OIS-y coil (620)’ may be referred to as ‘first-first coil,’ and the other as ‘first-second coil.’

Hereinafter, one of the ‘AF substrate (710)’ and ‘OIS substrate (720)’ may be referred to as a ‘first substrate,’ and the other may be referred to as a ‘second substrate.’

Hereinafter, one of the ‘AF guide ball (810)’ and ‘OIS guide ball’ may be referred to as a ‘first ball,’ and the other may be referred to as a ‘second ball.’

Hereinafter, one of the ‘AF guide ball (810),’ ‘OIS-x guide ball (821),’ and ‘OIS-y guide ball (822)’ may be referred to as a ‘first ball,’ the other as a ‘second ball,’ and the remaining one as a ‘third ball.’ Alternatively, when the ‘OIS guide ball’ is referred to as a ‘first ball,’ one of the ‘OIS-x guide ball (821)’ and ‘OIS-y guide ball (822)’ may be referred to as a ‘first-first ball,’ and the other as a ‘first-second ball.’

Hereinafter, one of the ‘fixed part (100)’, ‘AF moving part (200)’ and ‘OIS moving part (300)’ may be referred to as a ‘first member’, another as a ‘second member’ and the other as a ‘third member’.

Hereinafter, one of the ‘AF sensor (430)’, ‘OIS-x sensor (530)’, and ‘OIS-y sensor (630)’ may be referred to as a ‘first sensor’, another as a ‘second sensor’, and the remaining one as a ‘third sensor’.

Hereinafter, one of the individual balls of the AF guide ball (810), the OIS-x guide ball (821), and the OIS-y guide ball (822) may be referred to as a ‘first unit ball,’ another as a ‘second unit ball,’ another as a ‘third unit ball,’ and another as a ‘fourth unit ball.’ Furthermore, ‘nth unit ball’ may be used to refer to individual balls such as a ‘fifth unit ball,’ ‘sixth unit ball,’ and so on.

Hereinafter, one of the ‘column part (111)’ and ‘outer wall part (112)’ may be referred to as a ‘first portion,’ and the other may be referred to as a ‘second portion.’

Hereinafter, one of the ‘inner groove (111-1)’ and ‘outer groove (112-1)’ may be referred to as a ‘first groove,’ and the other as a ‘second groove.’

Hereinafter, one of the ‘inner groove (224-1)’ and ‘outer groove (224-2)’ may be referred to as a ‘first groove,’ and the other as a ‘second groove.’

Hereinafter, one of the ‘inner ball (811)’ and ‘outer ball (812)’ may be referred to as a ‘first unit ball,’ and the other as a ‘second unit ball.’

Hereinafter, one of the ‘inner uppermost balls (811-1)’ and ‘outer uppermost balls (812-1)’ may be referred to as a ‘first uppermost ball,’ and the other as a ‘second uppermost ball.’

Hereinafter, one of the ‘inner lowermost balls (811-2)’ and ‘outer lowermost balls (812-2)’ may be referred to as a ‘first lowermost ball,’ and the other may be referred to as a ‘second lowermost ball.’

The configuration of a lens driving device according to the present embodiment will be described below with reference to the drawings.

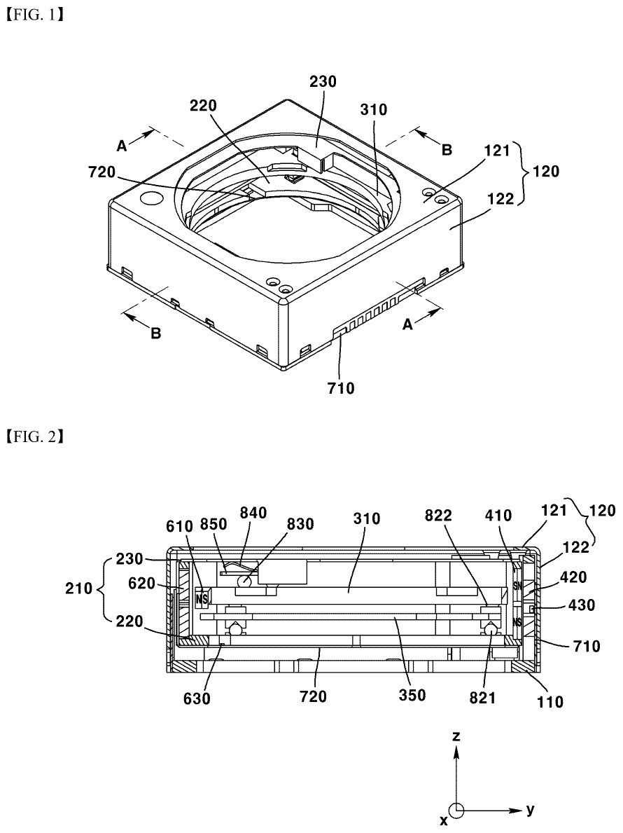

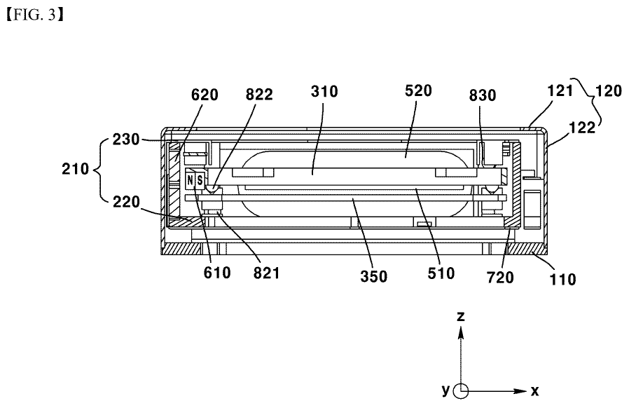

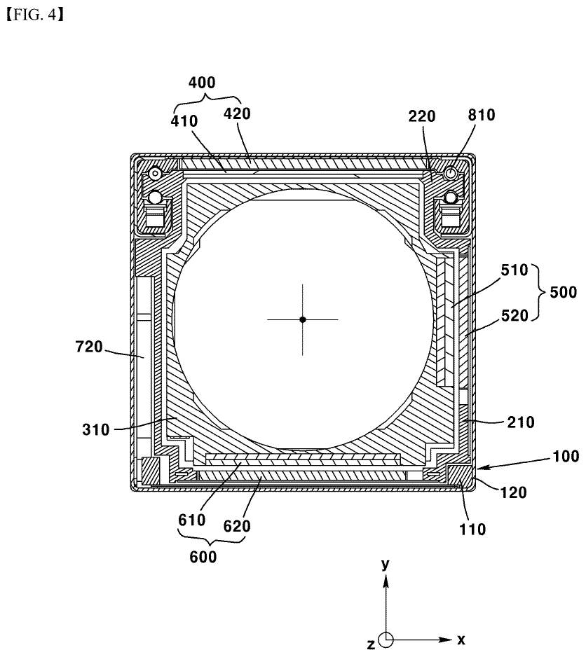

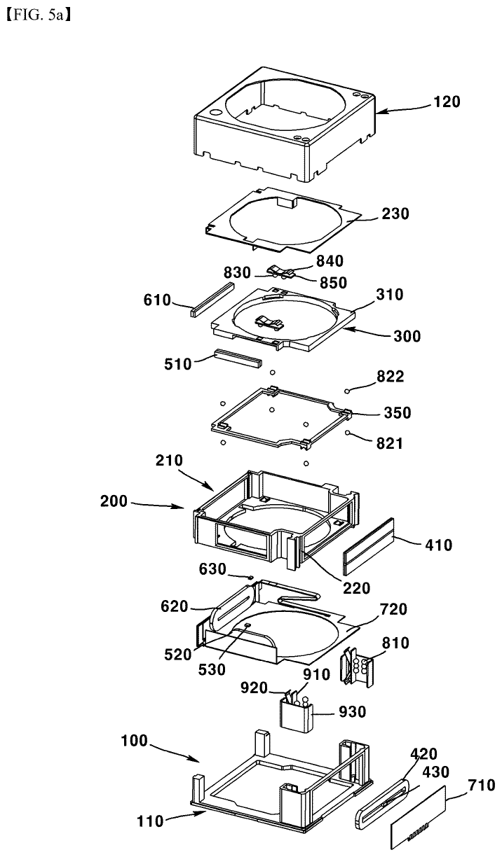

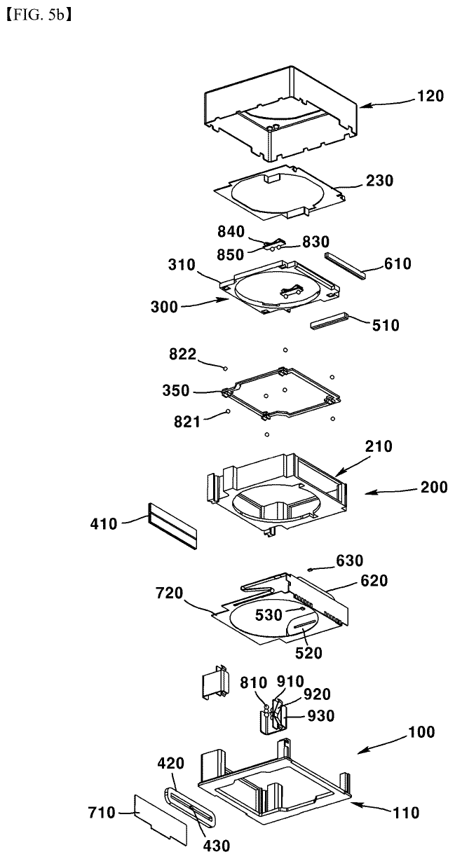

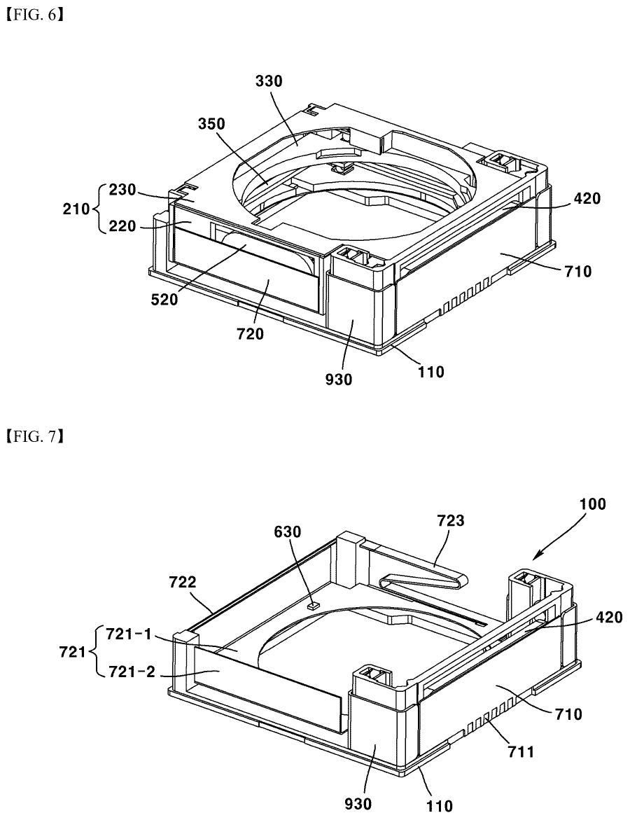

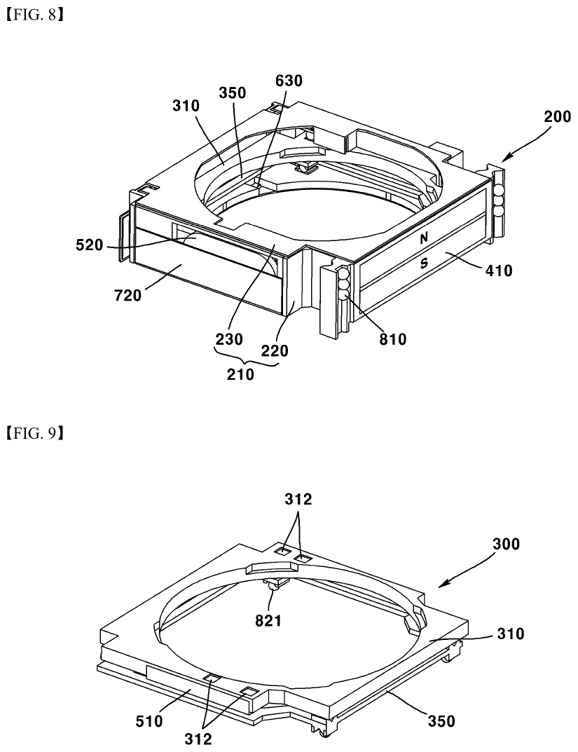

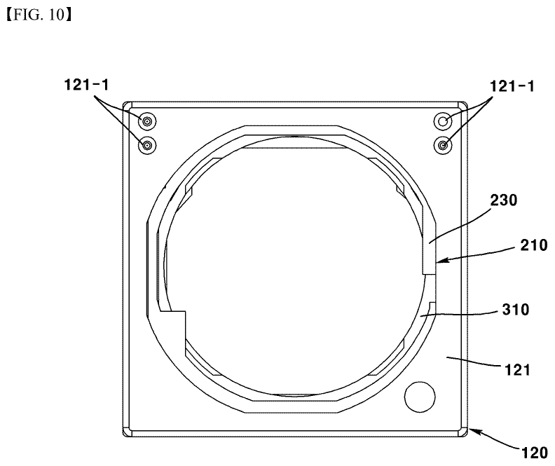

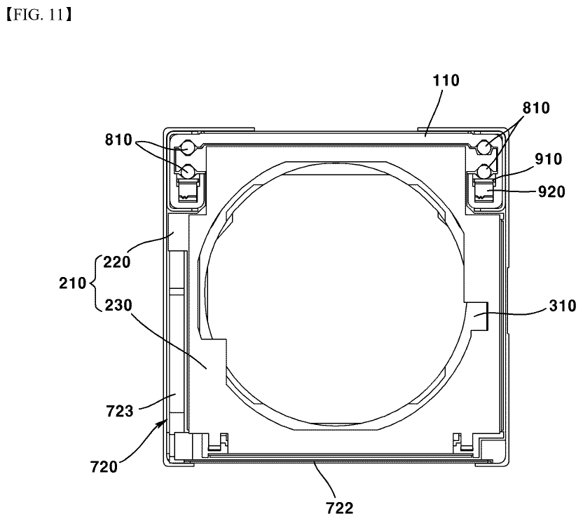

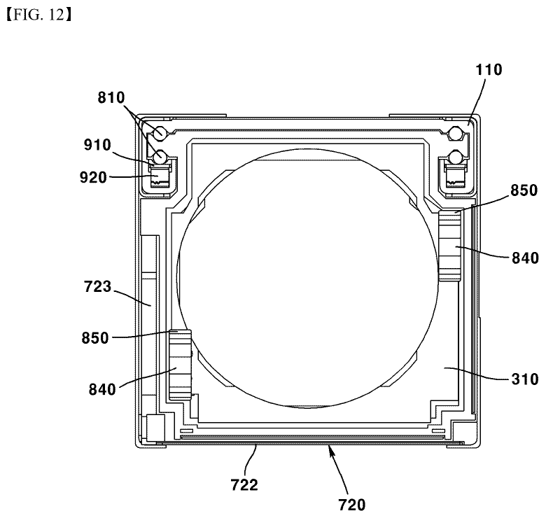

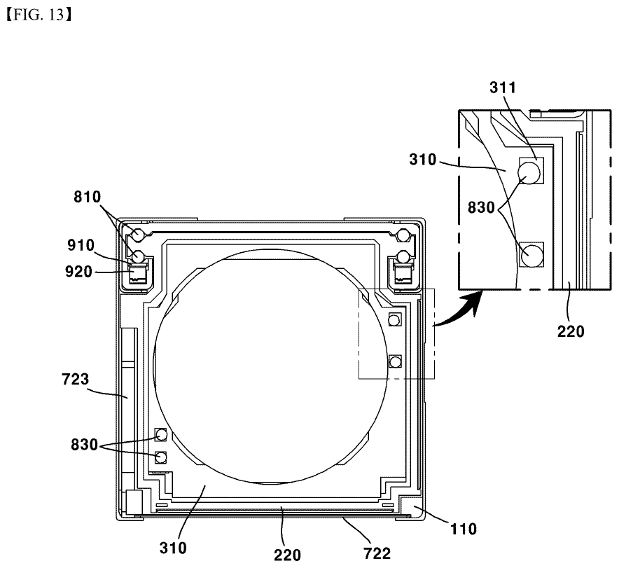

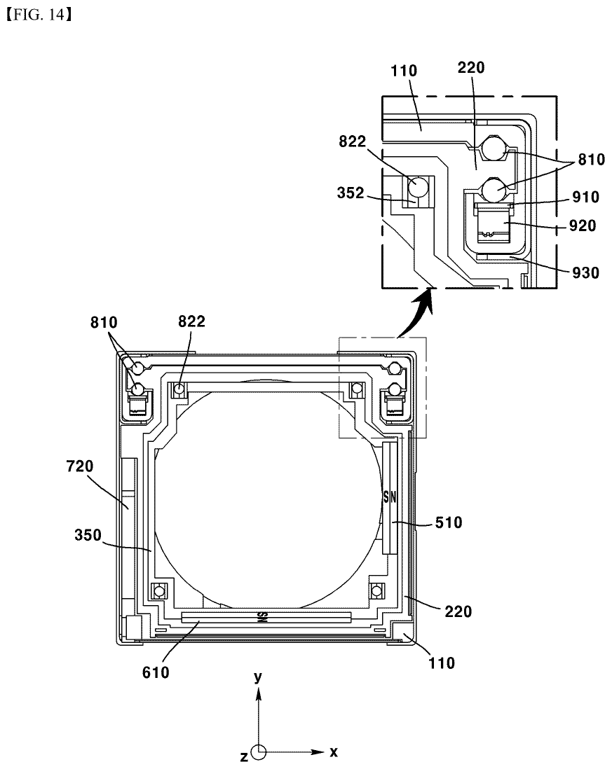

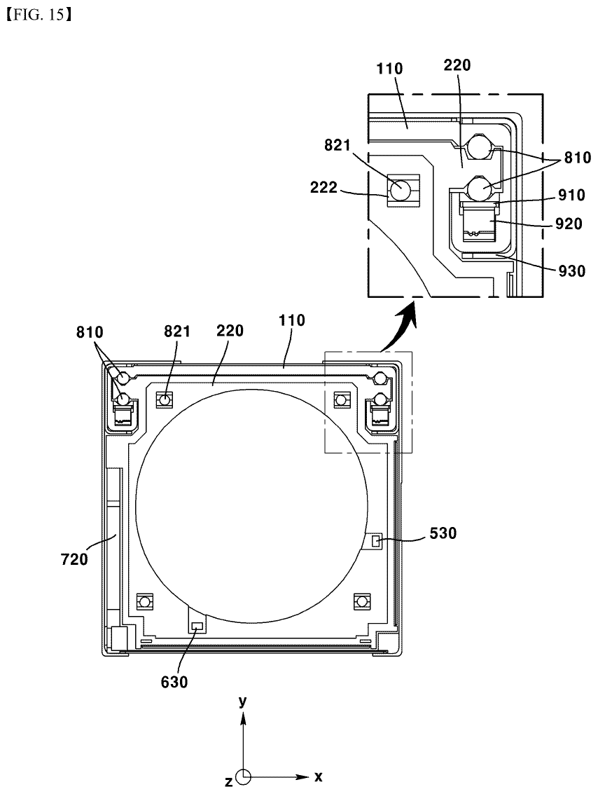

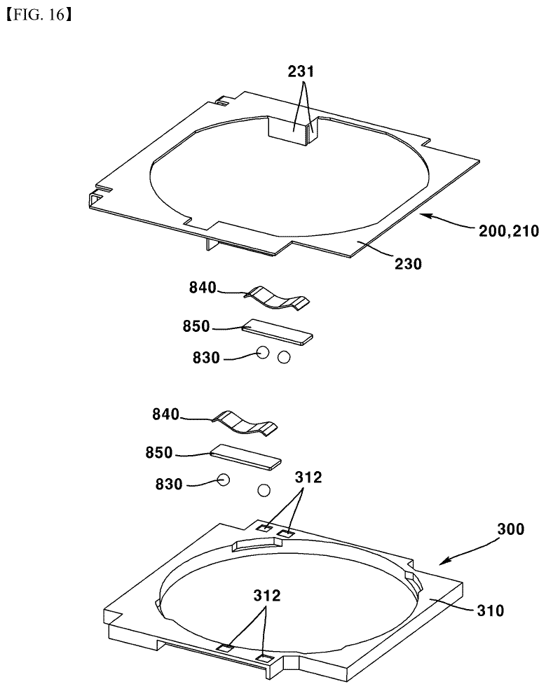

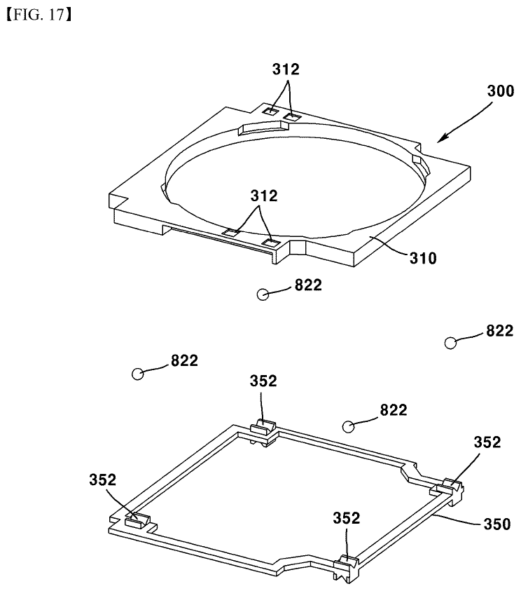

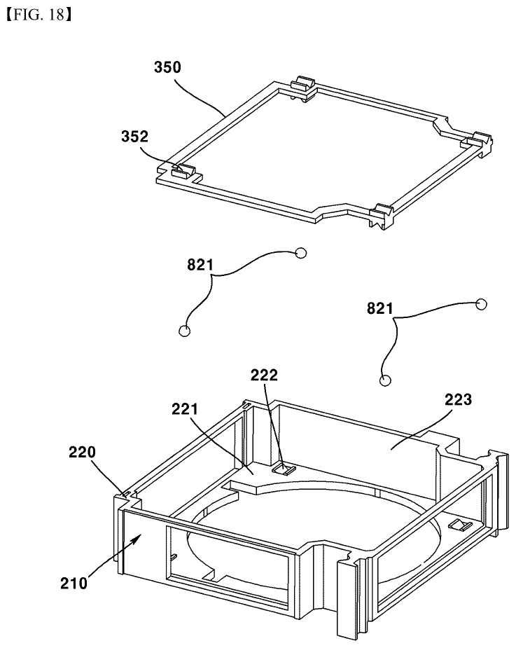

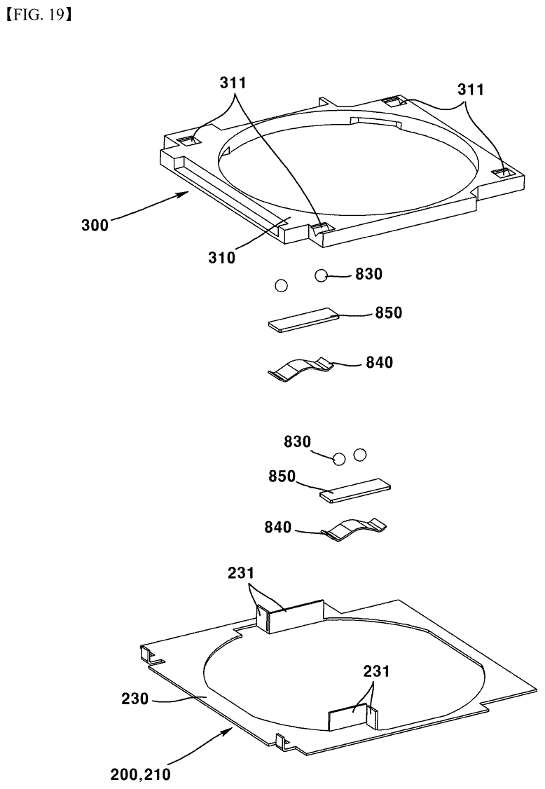

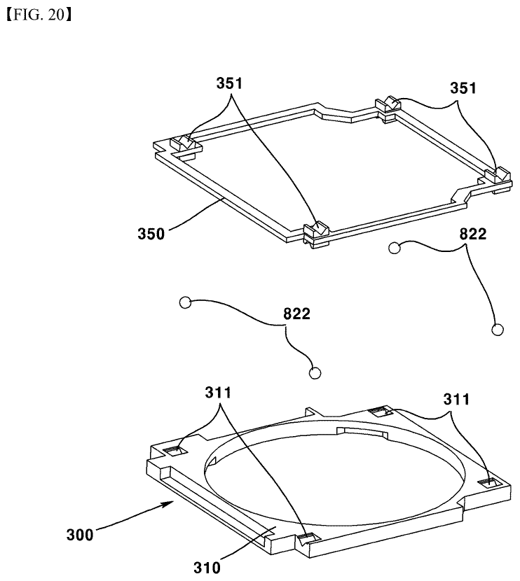

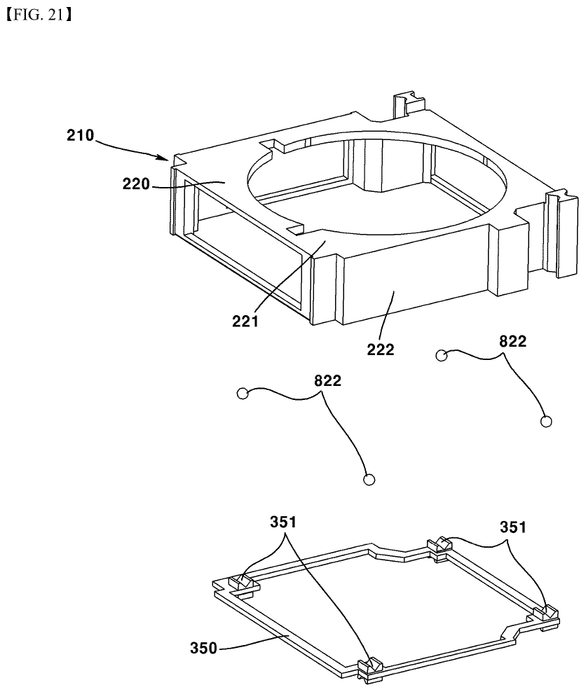

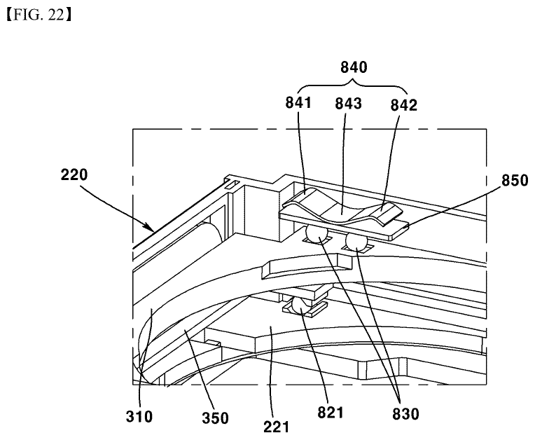

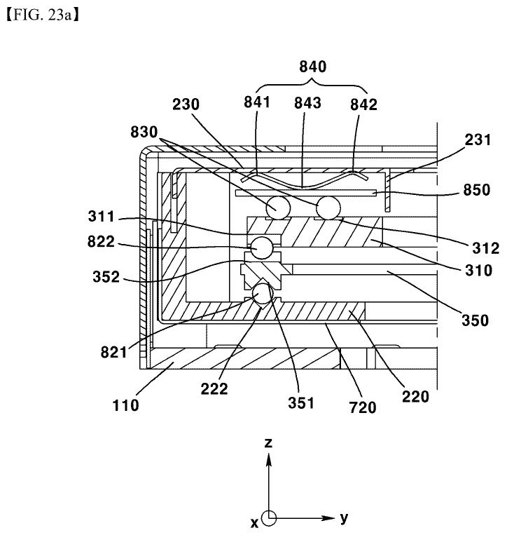

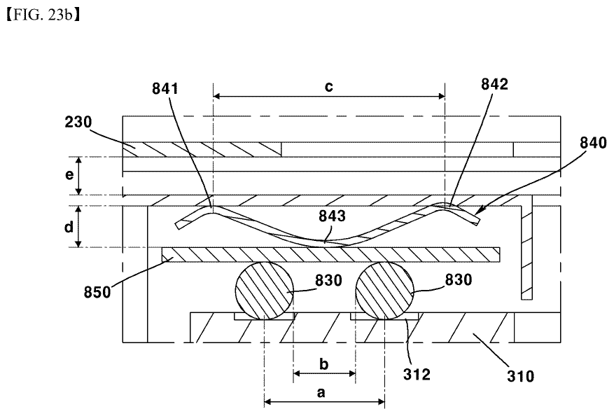

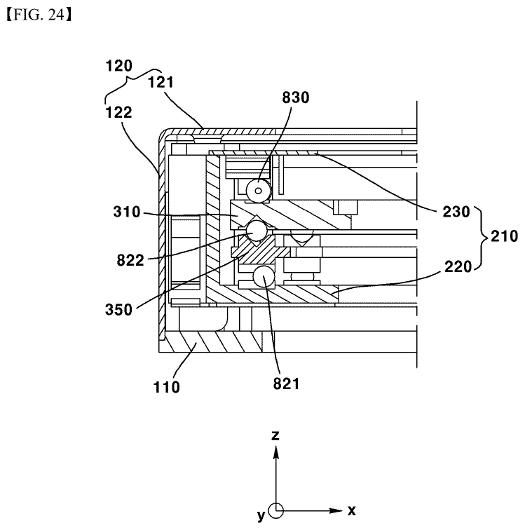

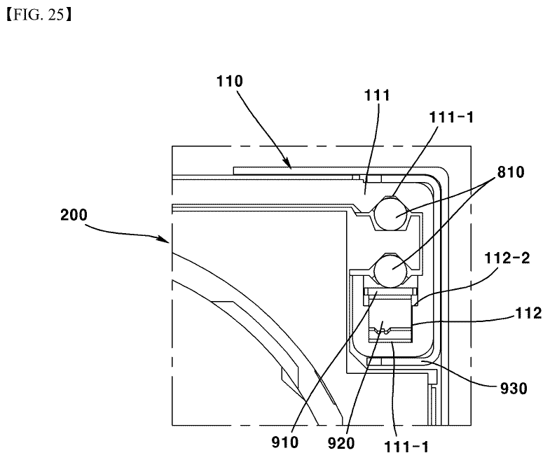

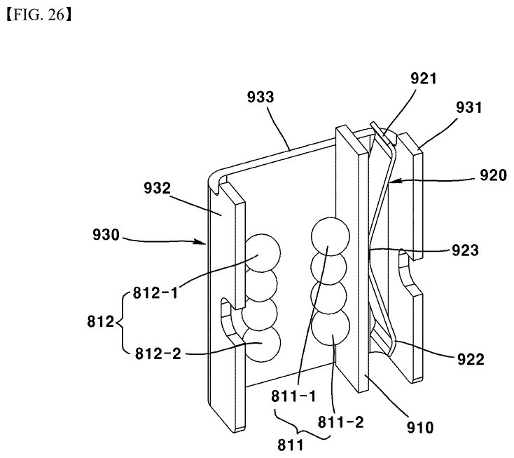

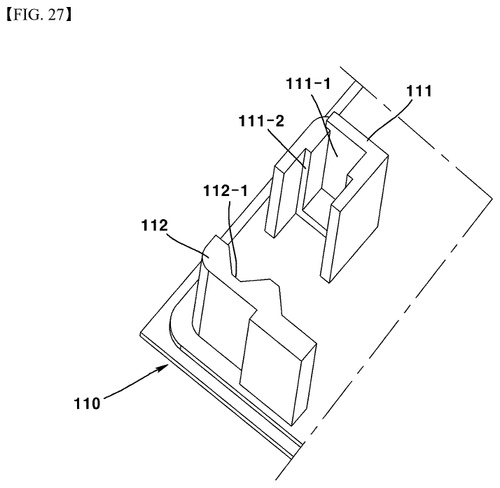

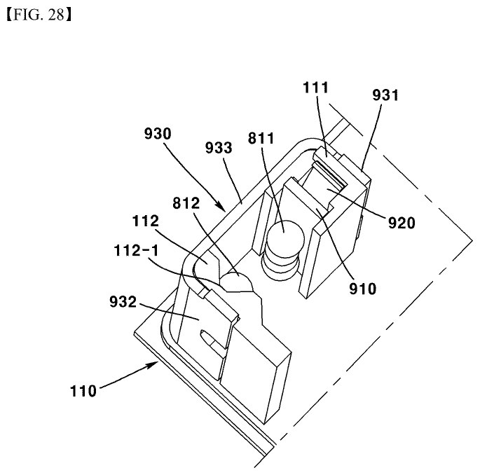

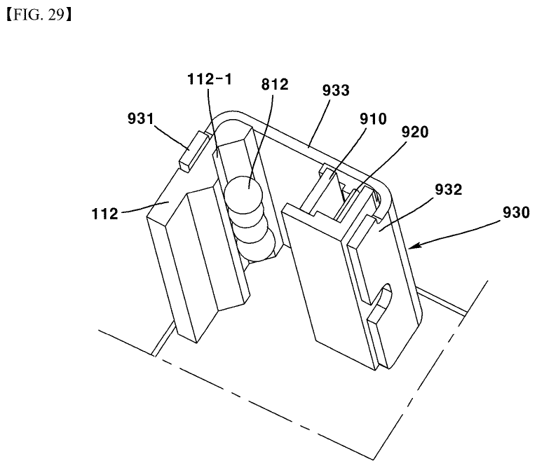

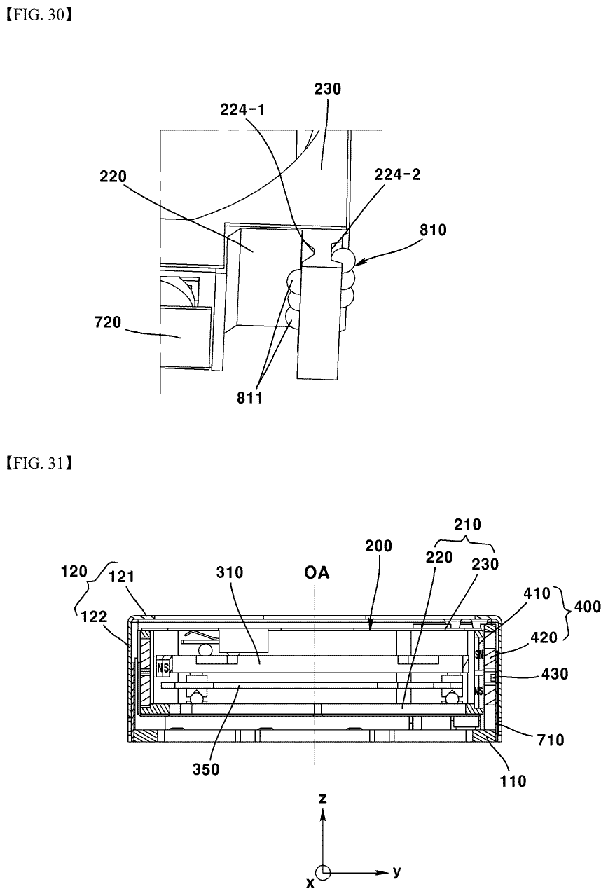

FIG. 1 is a perspective view of a lens driving device according to an embodiment of the present disclosure, FIG. 2 is a cross-sectional view of the lens driving device shown in FIG. 1, taken along A-A line, FIG. 3 is a cross-sectional view of the lens driving device shown in FIG. 1, taken along B-B line, FIG. 4 is a cross-sectional view of a lens driving device, cut perpendicular to an optical axis and viewed from above, according to an embodiment of the present disclosure, FIG. 5a is an exploded perspective view of a lens driving device according to an embodiment of the present disclosure, FIG. 5b is an exploded perspective view of the lens driving device shown in FIG. 5a, viewed from a different direction, FIG. 6 is a perspective view of a lens driving device according to an embodiment of the present disclosure, with a cover omitted, FIG. 7 is a perspective view showing a configuration related to a fixed part of a lens driving device according to an embodiment of the present disclosure, FIG. 8 is a perspective view showing a configuration related to a moving part of a lens driving device according to an embodiment of the present disclosure, FIG. 9 is a perspective view showing a configuration related to an OIS moving part of a lens driving device according to an embodiment of the present disclosure, FIG. 10 is a plan view of a lens driving device according to an embodiment of the present disclosure, FIG. 11 is a plan view of FIG. 10 with a cover removed, FIG. 12 is a plan view of FIG. 11 with a cover removed, FIG. 13 is a plan view of FIG. 12 with a plate member removed and a partially enlarged view, FIG. 14 is a plan view of FIG. 13 with an OIS carrier removed and a partially enlarged view, FIG. 15 is a plan view of FIG. 14 with a guide member removed and a partially enlarged view, FIG. 16 is an exploded perspective view showing a cover, an OIS ball pressing member, and an OIS carrier, FIG. 17 is an exploded perspective view showing an OIS carrier, an OIS-y guide ball, and a guide member, FIG. 18 is an exploded perspective view showing a guide member, an OIS-x guide ball, and a holder member, FIG. 19 is a bottom exploded perspective view of FIG. 16 from a different direction, FIG. 20 is a bottom exploded perspective view of FIG. 17 from a different direction, FIG. 21 is a bottom exploded perspective view of FIG. 18 from a different direction, FIG. 22 is a perspective view showing a configuration related to an OIS ball pressing member, FIG. 23a is a cross-sectional view showing a configuration related to an OIS ball pressing member and an OIS guide ball, FIG. 23b is an enlarged view of a portion of FIG. 23a, FIG. 24 is a cross-sectional view of a configuration related to an OIS ball pressing member and an OIS guide ball, viewed by cutting in a direction perpendicular to FIG. 23a, FIG. 25 is a plan view showing a structure related to an AF guide ball according to an embodiment of the present disclosure, FIG. 26 is a perspective view showing a configuration related to an AF guide ball of a lens driving device according to an embodiment of the present disclosure, FIG. 27 is a perspective view showing a structured related to an AF guide ball of a base of a lens driving device according to an embodiment of the present disclosure, FIG. 28 is a perspective view showing a state in which a ball, a plate member, an elastic member and reinforcing member are disposed in FIG. 27, FIG. 29 is a perspective view of FIG. 28 viewed from a different direction, and FIG. 30 is a perspective view showing an AF moving part and an AF guide ball of a lens driving device according to an embodiment of the present disclosure.

A lens driving device (10) may be a voice coil motor (VCM). The lens driving device (10) may be a lens driving motor. The lens driving device (10) may be a lens driving actuator. The lens driving device (10) may comprise an AF module. The lens driving device (10) may comprise an OIS module.

The lens driving device (10) may comprise a fixed part (100). The fixed part (100) may be a part that is relatively fixed when a moving part moves. The moving part may move relative to the fixed part (100).

The lens driving device (10) may comprise a base (110). The fixed part (100) may comprise a base (110). The base (110) may be disposed below an AF carrier (210). The base (110) may be disposed below an OIS carrier (310). The base (110) may be coupled to a cover (120). The AF carrier (210) and the OIS carrier (310) may be disposed on the base (110). The AF carrier (210) and the OIS carrier (310) may be disposed on the lower surface of the base (110). The AF carrier (210) and the OIS carrier (310) may be disposed within the base (110). The AF carrier (210) and the OIS carrier (310) may be disposed within a side wall portion of the base (110).

The base (110) may comprise a lower plate part. The lower plate part of the base (110) may support the lower surface of an AF moving part (200). The lower plate part of the base (110) may support the lower surface of an AF carrier (210).

The base (110) may comprise a column part (111). The column part (111) may extend from the upper surface of the lower plate part. The column part (111) may be disposed on the inner side of the outer wall part (112).

The base (110) may comprise an inner groove (111-1). The column part (111) may comprise the inner groove (111-1). The inner groove (111-1) may be formed in the column part (111). The inner groove (111-1) may be an “AF guide ball receiving groove”. The inner groove (111-1) may accommodate an AF guide ball (810). The inner groove (111-1) may accommodate an inner ball (811). The inner groove (111-1) may be in direct contact with the AF guide ball (810). The inner groove (111-1) may be disposed in the optical axis direction. The inner groove (111-1) may comprise multiple grooves. The inner groove (111-1) may comprise two grooves. The two grooves may be disposed parallel to each other. The two grooves may be disposed diagonally relative to the optical axis.

The base (110) may comprise a staircase (111-2). The staircase (111-2) may be formed on the column part (111). A plate member (910) may be disposed on the staircase (111-2).

The base (110) may comprise an outer wall part (112). The outer wall part (112) may be a “side part”. The outer wall part (112) may be a “side plate”. The outer wall part (112) may be a “side wall”. The outer wall part (112) of the base (110) may extend from the upper surface of the lower plate part.

The base (110) may comprise an outer groove (112-1). The outer wall part (112) may comprise the outer groove (112-1). The outer groove (112-1) may be formed facing the inner groove (111-1). The outer groove (112-1) may be disposed facing the inner groove (111-1). The outer groove (112-1) may be an “AF guide ball receiving groove”. The outer groove (112-1) may accommodate an AF guide ball (810). The outer groove (112-1) may accommodate an outer ball (812). The outer groove (112-1) may come into direct contact with the AF guide ball (810). The outer groove (112-1) may be disposed in the optical axis direction. The outer groove (112-1) may comprise multiple grooves. The outer groove (112-1) may comprise two grooves. The two grooves may be disposed parallel to each other. The two grooves may be disposed diagonally relative to the optical axis. The outer groove (112-1) may be disposed opposite the inner groove (111-1). The outer groove (112-1) may form a shape corresponding to the inner groove (111-1). The outer groove (112-1) and the inner groove (111-1) may be formed with the same length in the optical axis direction.

The base (110) may comprise a staircase. The staircase may be formed at the lower end part of the outer surface of the base (110). The staircase may protrude from the outer surface of the base (110). The side plate (122) of the cover (120) may be disposed on the staircase of the base (110).

The lens driving device (10) may comprise a cover (120). The fixed part (100) may comprise a cover (120). The cover (120) may be disposed on the base (110). The cover (120) may be disposed on top of the base (110). The cover (120) may be coupled to the base (110). The cover (120) may be fixed to the base (110). The cover (120) may accommodate the AF carrier (210) internally. The cover (120) may accommodate the OIS carrier (310) internally. The cover (120) may be a shield member. The cover (120) may be a shield can.

The cover (120) may comprise an upper plate (121). The upper plate (121) may be disposed on the moving part. The upward movement of the moving part may be restricted by the moving part from contacting the upper plate (121). The upper plate (121) may comprise a hole through which light passes.

The cover (120) may comprise a bent part (122). The bent part (122) may be formed on the upper plate (121). The bent part (122) may be formed to prevent the AF guide ball (810) from moving upward. The bent part (122) may be formed to protrude downward from the upper plate (121). The bent part (122) may overlap with the AF guide ball (810) in the optical axis direction.

The cover (120) may comprise side plates (122). The side plates (122) may extend from the upper plate (121). The side plates (122) may be disposed on the base (110). The side plates (122) may be disposed on a staircase part formed on the lower end part of the outer surface of the base (110). The side plate (122) may comprise multiple side plates. The side plate (122) may comprise four side plates. The side plate (122) may comprise a first side plate and a second side plate disposed on opposite sides, and a third side plate and a fourth side plate disposed on opposite sides.

The lens driving device (10) may comprise a moving part. The moving part may be disposed on the fixed part (100). The moving part may be disposed within the fixed part (100). The moving part may be disposed on the fixed part (100). The moving part may be disposed movably on the fixed part (100). The moving part may be moved relative to the fixed part (100) by a driving part. The moving part may be moved during AF drive. The moving part can move during OIS drive (operation). A lens may be coupled to the moving part.

The lens driving device (10) may comprise an AF moving part (200). The AF moving part (200) may be disposed on the fixed part (100). The AF moving part (200) may be disposed within the fixed part (100). The AF moving part (200) may be disposed on the fixed part (100). The AF moving part (200) may be disposed between the fixed part (100) and the OIS moving part (300). The AF moving part (200) may be movably disposed on the fixed part (100). The AF moving part (200) may be moved in the optical axis direction relative to the fixed part (100) by the AF driving part (400). The AF moving part (200) can move during AF drive (operation).

In a modified example, the AF moving part (200) and the AF driving part (400) may be omitted. In other words, the OIS moving part (300) may be disposed on the fixed part (100). Alternatively, the OIS moving part (300) may be disposed on the fixed part (100), and the AF moving part (200) may be disposed within the OIS moving part (300).

The lens driving device (10) may comprise an AF carrier (210). The AF moving part (200) may comprise the AF carrier (210). The AF carrier (210) may be an “AF holder”. The AF carrier (210) may be a “housing”. The AF carrier (210) may be disposed within the base (110). The AF carrier (210) may be disposed on the base (110). The AF carrier (210) may be disposed within the cover (120). The AF carrier (210) may be disposed between the base (110) and the OIS carrier (310). The AF carrier (210) may be disposed so as to be movable in the optical axis direction.

The AF carrier (210) may comprise a lower plate. The AF carrier may comprise an upper plate. In this case, the lower plate may be part of the holder member (220). The upper plate may be a cover (230). The housing may comprise a first housing and a second housing. In this case, the first housing may comprise the holder member (220), and the second housing may comprise the cover (230). The OIS carrier (310) may be a bobbin. The OIS guide ball may be disposed between the housing and the bobbin. The AF guide ball (810) may be disposed between the side surface of the housing and the cover (120). The AF guide ball (810) may be disposed between the side surface of the housing and the base or the column of the base.

The lens driving device (10) may comprise a holder member (220). The AF carrier (210) may comprise the holder member (220). The holder member (220) may be formed separately from the cover (230). The holder member (220) may be disposed on the base (110). The holder member (220) may be disposed within the base (110). The holder member (220) may be disposed within the cover (120). The holder member (220) may be disposed between the base (110) and an OIS carrier (310). The holder member (220) may be disposed between the cover (120) and the OIS carrier (310).

The holder member (220) may comprise a lower plate (221). The lower plate (221) of the holder member (220) may be disposed below the OIS carrier (310). The lower plate (221) of the holder member (220) may be disposed on the base (110). The lower plate (221) of the holder member (220) may be disposed between the OIS carrier (310) and the base (110).

The AF carrier (210) may comprise a groove (222). The groove (222) may be an “OIS-x guide ball receiving groove”. The holder member (220) may comprise the groove (222). The lower plate (221) of the holder member (220) may comprise the groove (222). The groove (222) may be formed on the lower plate (221) of the holder member (220). The groove (222) may be formed on the upper surface of the lower plate (221) of the holder member (220). The groove (222) may be disposed in the x-axis direction. The OIS-x guide ball (821) may be disposed in the groove (222). The groove (222) may guide the OIS-x guide ball (821) to move in the x-axis direction.

The AF carrier (210) may comprise a side wall (223). The side wall (223) may accommodate an OIS substrate (720). The side wall (223) may accommodate an AF magnet (410). The side wall (223) may comprise an OIS-x coil (520). The side wall (223) may comprise an OIS-y coil (620). The side wall (223) may comprise a hole or groove for accommodating the AF magnet (410). The side wall (223) may comprise a hole or groove for accommodating the coils. The side wall (223) may comprise multiple side walls. The side wall (223) may comprise four side walls. The side wall (223) may comprise a first side wall and a second side wall disposed on opposite sides, and a third side wall and a fourth side wall disposed on opposite sides.

The AF carrier (210) may comprise an inner groove (224-1). The holder member (220) may comprise an inner groove (224-1). The inner groove (224-1) may be an “AF guide ball receiving groove”. The inner groove (224-1) may accommodate an AF guide ball (810). The inner groove (224-1) may accommodate an inner ball (811). The inner groove (224-1) may come into direct contact with the AF guide ball (810). The inner groove (224-1) may be disposed in the optical axis direction. The inner groove (224-1) can guide the AF guide ball (810) to move in the optical axis direction. The inner groove (224-1) may comprise multiple grooves. The inner groove (224-1) may comprise two grooves. The two grooves may be disposed in parallel with each other.

The two grooves may be disposed diagonally relative to the optical axis. The AF carrier (210) may comprise an outer groove (224-2). The holder member (220) may comprise an outer groove (224-2). The outer groove (224-2) may be an “AF guide ball receiving groove”.

The outer groove (224-2) may accommodate the AF guide ball (810). The outer groove (224-2) may accommodate an outer ball (812). The outer groove (224-2) may come into direct contact with the AF guide ball (810). The outer groove (224-2) may be disposed in the optical axis direction. The outer groove (224-2) may guide the AF guide ball (810) to move in the optical axis direction. The outer groove (224-2) may comprise multiple grooves. The outer groove (224-2) may comprise two grooves.

The two grooves may be disposed parallel to each other. The two grooves may be disposed diagonally to each other with respect to the optical axis. The outer groove (224-2) may be disposed opposite to the inner groove (224-1). The outer groove (224-2) can form a shape corresponding to that of the inner groove (224-1). The outer groove (224-2) and the inner groove (224-1) may be formed to have the same length in the optical axis direction.

The lens driving device (10) may comprise a cover (230). The AF carrier (210) may comprise a cover (230). The cover (230) may be coupled to the holder member (220). The cover (230) may be coupled to the upper surface of the holder member (220). The cover (230) may be inserted from the upper side and coupled to the holder member (220). The cover (230) may be coupled to the holder member (220) by a hook shape. The cover (230) may comprise a hole, and the holder member (220) may comprise a hook-shaped protrusion that engages with the hole of the cover (230) when coupled. The cover (230) may be disposed between the holder member (220) and the upper plate (121) of the cover (120). The cover (230) may be disposed between the OIS carrier (310) and the upper plate (121) of the cover (120).

The cover (230) may comprise an upper plate. The upper plate may be disposed on the OIS carrier (310). An elastic member (840) may be disposed on the upper plate.

The cover (230) may comprise an extension part (231). The extension part (231) may be bent and extended from the upper plate. The extension part (231) may be extended downward from the upper plate. The extension part (231) may be formed in a shape to prevent a pressing ball (830), an elastic member (840) and the plate member (850) from coming off.

The lens driving device (10) may comprise an OIS moving part (300). The OIS moving part (300) may be disposed within the fixed part (100). The OIS moving part (300) may be disposed within the fixed part (100). The OIS moving part (300) may be disposed on the fixed part (100). The OIS moving part (300) may be disposed within the AF moving part (200). The OIS moving part (300) may be disposed in a movable manner. The OIS moving part (300) may be moved in a direction perpendicular to the optical axis relative to the fixed part (100) and the AF moving part (200) by the OIS driving part. The OIS moving part (300) may be moved in the x-axis direction by the OIS-x driving part (500). The OIS moving part (300) may be moved in the y-axis direction by an OIS-y driving part (600). The OIS moving part (300) can move during OIS drive (operation).

The lens driving device (10) may comprise an OIS carrier (310). The OIS moving part (300) may comprise an OIS carrier (310). The OIS carrier (310) may be an “OIS holder”. The OIS carrier (310) may be a “bobbin”. The OIS carrier (310) may be disposed within the AF carrier (210). The OIS carrier (310) may be disposed within the base (110). The OIS carrier (310) may be disposed on the base (110). The OIS carrier (310) may be disposed within the cover (120). The OIS carrier (310) may be disposed so as to be movable in a direction perpendicular to the optical axis.

The OIS carrier (310) may be disposed between the upper plate and the lower plate of the AF carrier (210). The OIS carrier (310) may be disposed between the cover (230) and the lower plate (221) of the holder member (220).

The OIS carrier (310) may comprise an outer surface. The OIS carrier (310) may comprise multiple surfaces. The OIS carrier (310) may comprise a first surface and a second surface disposed on opposite sides, and a third surface and a fourth surface disposed on opposite sides. An OIS-x magnet (510) may be disposed on the third side surface of the OIS carrier (310). The OIS-y magnet (610) may be disposed on the second side surface of the OIS carrier (310).

The OIS carrier (310) may comprise a groove (311). The groove (311) may be an “OIS-y guide ball receiving groove”. An OIS-y guide ball (822) may be disposed in the groove (311). The groove (311) may be in direct contact with the OIS-y guide ball (822). The groove (311) may be formed on the lower surface of the OIS moving part (300). The groove (311) may be formed on the lower surface of the OIS carrier (310). The groove (311) may be disposed in the y-axis direction. The groove (311) may comprise multiple grooves. The groove (311) may comprise four grooves. The groove (311) may be formed concavely on the lower surface of the OIS carrier (310). The groove (311) may be formed as a V-shaped groove. One or more of the four grooves may be formed such that it can move in both the x-axis direction and the y-axis direction.

The OIS carrier (320) may comprise a groove (312). The groove (312) may be a “pressing ball receiving groove”. A pressing ball (830) may be disposed in the groove (312). The groove (312) may be formed on the upper surface of the OIS carrier (320). The groove (312) may be formed concavely on the upper surface of the OIS carrier (320). The groove (312) may accommodate at least a portion of the pressing ball (830). The pressing ball (830) may move within the groove (312). The groove (312) may comprise multiple grooves. The groove (312) may comprise four grooves.

One of the grooves (311) and (312) of the OIS carrier (310) may be referred to as a “first groove” and the other as a “second groove”.

The OIS carrier (310) may comprise a lateral stopper. The lateral stopper can limit the lateral stroke of the OIS carrier (310). That is, when the OIS carrier (310) moves to its maximum position, the lateral stopper of the OIS carrier (310) may come into contact with one or more of the AF carrier (210) and the base (110). The lateral stopper may be formed on the outer surface of the OIS carrier (310). The lateral stopper may protrude outward from the side surface of the OIS carrier (310).

The OIS carrier (310) may comprise a groove. The groove may be a “lens adhesive receiving groove”. The groove may be formed on the inner surface of the OIS carrier (310). The groove may be formed concavely on the inner surface of the OIS carrier (310). Adhesive may be injected between the lens and the OIS carrier (310) through the groove. Adhesive for bonding the lens and the OIS carrier (310) may be disposed in the groove.

The OIS carrier (310) may comprise a mounting part. The mounting part may be a “magnet mounting part”. Magnets (510, 610) may be disposed in the mounting part. The mounting part may, for example, be formed as a groove.

The lens driving device (10) may comprise a guide member (350). The OIS moving part (300) may comprise a guide member (350). The guide member (350) may be disposed between the lower plate of the AF carrier (210) and the OIS carrier (310). The OIS carrier (310) may be disposed between the guide member (350) and the upper plate of the AF carrier (210). The guide member (350) may be disposed between the lower plate (221) of the holder member (220) and the OIS carrier (310). The OIS carrier (310) may be disposed between the guide member (350) and the cover (230).

The guide member (350) may comprise a groove (351). The groove (351) may be an “OIS-x guide ball receiving groove”. The groove (351) may be formed on the lower surface of the guide member (350). The groove (222) may be disposed in the x-axis direction. The OIS-x guide ball (821) may be disposed in the groove (222). The groove (222) may guide the OIS-x guide ball (821) to move in the x-axis direction. The groove (351) may come into direct contact with the OIS-x guide ball (821). The groove (351) may comprise multiple grooves. The groove (351) may comprise four grooves. The groove (351) may be formed as a V-shaped groove. The groove (351) may be formed as a U-shaped groove. The groove (351) may comprise multiple V-shaped grooves and multiple U-shaped grooves. The groove (351) may comprise three V-shaped grooves and one U-shaped groove. The groove (351) may comprise two V-shaped grooves and two U-shaped grooves. The groove (351) may comprise one V-shaped groove and three U-shaped grooves. One or more of the four grooves may be a groove to allow being moved both to the x-axis direction and the y-axis direction.

The guide member (350) may comprise a groove (352). The groove (352) may be an “OIS-y guide ball receiving groove”. The groove (352) may be formed on the upper surface of the guide member (350). The groove (352) may be disposed in the y-axis direction. The groove (352) may accommodate the OIS-y guide ball (822). The groove (352) may guide the OIS-y guide ball (822) to move in the y-axis direction. The groove (352) may come into direct contact with the OIS-y guide ball (822). The groove (352) may comprise multiple grooves. The groove (352) may comprise four grooves. The groove (352) may be formed as a V-shaped groove. The groove (352) may be formed as a U-shaped groove. The groove (352) may comprise multiple V-shaped grooves and multiple U-shaped grooves. The groove (352) may comprise three V-shaped grooves and one U-shaped groove. The groove (352) may comprise two V-shaped grooves and two U-shaped grooves. The groove (352) may comprise one V-shaped groove and three U-shaped grooves. One or more of the four grooves may be formed such that they can move in both the x-axis direction and the y-axis direction.

One of the “grooves (351)” and “grooves (352)” of the guide member (350) may be referred to as a “first groove”, and the other may be referred to as a “second groove”.

The lens driving device (10) may comprise a driving part. The driving part is capable of moving the moving part relative to the fixed unit (100). The driving part may comprise an AF driving part (400). The driving part may comprise an OIS driving part. The driving part may comprise an OIS-x driving part (500). The driving part may comprise an OIS-y driving part (600). The driving part may comprise a coil and a magnet.

The lens driving device (10) may comprise an AF driving part (400). The AF driving part (400) may move the AF moving part (200) in the optical axis direction. The AF driving part (400) may move the AF carrier (210) in the optical axis direction. The AF driving part (400) may move the AF carrier (210) in the optical axis direction relative to the base (110). The AF driving part (400) may move the AF carrier (210) in the optical axis direction through electromagnetic force. The AF driving part (400) may comprise a coil and a magnet. The OIS moving part (300) may move together with the AF moving part (200) when the AF moving part (200) moves in the optical axis direction.

In this embodiment, the AF carrier (210) and the OIS carrier (310) may move in the optical axis direction due to the interaction between the AF coil (420) and the AF magnet (410). The AF magnet (410), the AF carrier (210), and the OIS carrier (310) may move integrally in the optical axis direction.

The lens driving device (10) may comprise an AF magnet (410). The AF driving part (400) may comprise an AF magnet (410). The AF magnet (410) may be an “AF magnet”. The AF magnet (410) may be a permanent magnet. The AF magnet (410) may be disposed in the AF moving part (200). The AF magnet (410) may be disposed in the AF carrier (210). The AF magnet (410) may be disposed in the holder member (220). The AF magnet (410) may be disposed within the cover (120). The AF magnet (410) may be fixed to the AF carrier (210). The AF magnet (410) may be coupled to the AF carrier (210). The AF magnet (410) may be adhered to the AF carrier (210) with an adhesive. The AF magnet (410) may interact with the AF coil (420). The AF magnet (410) may interact electromagnetically with the AF coil (420). The AF magnet (410) may be disposed at a corresponding location relative to the AF coil (420). The AF magnet (410) may face the AF coil (420). The AF magnet (410) may be opposite the AF coil (420). The AF magnet (410) may be superimposed on the AF coil (420) in a direction perpendicular to the optical axis.

The AF magnet (410) may be a 4-pole magnet. The AF magnet (410) may comprise a 4-pole permanent magnet. The AF magnet (410) may comprise a first magnet part comprising an N-pole and an S-pole, and a second magnet part comprising an N-pole and an S-pole. The first magnet part and the second magnet part may be disposed in a vertical direction. The first magnet part and the second magnet part may be spaced apart in a vertical direction, and a neutral part may be disposed between the first magnet part and the second magnet part.

The lens driving device (10) may comprise an AF coil (420). The AF driving part (400) may comprise an AF coil (420). The AF coil (420) may interact with the AF magnet (410). The AF coil (420) may be opposite to the AF magnet (410). The AF coil (420) may face the AF magnet (410). The AF coil (420) may be disposed at a location corresponding to that of the AF magnet (410). The AF coil (420) may overlap with the AF magnet (410) in a direction perpendicular to the optical axis. The AF coil (420) may be disposed on the AF substrate (710). The AF coil (420) may be disposed on the fixed part (100). The AF coil (420) may be disposed on the base (110). The AF coil (420) may be disposed inside the cover (120). The AF coil (420) may be disposed on the cover (120). The AF coil (420) may be disposed on the side plate (122) of the cover (120). The AF coil (420) may be disposed between the AF magnet (410) and the side plate (122) of the cover (120).

In this embodiment, the AF magnet (410) may move in the optical axis direction. The AF magnet (410) may move in the optical axis direction through interaction with the AF coil (420). The AF magnet (410) may move together with the AF moving part (200). The AF magnet (410) may move in the optical axis direction together with the AF moving part (200). During the AF drive process, the AF magnet (410) may move in the optical axis direction together with the AF moving part (200). The AF magnet (410) may be disposed in the AF moving part (200). The AF magnet (410) may be fixed to the AF moving part (200). The AF magnet (410) may be coupled to the AF moving part (200).

As a modified example or an alternative embodiment, the AF coil (420) may move in the optical axis direction. The AF coil (420) may move in the optical axis direction through interaction with the AF magnet (410). The AF coil (420) may move together with the AF moving part (200). The AF coil (420) may move in the optical axis direction together with the AF moving part (200). During the AF drive process, the AF coil (420) may move in the optical axis direction together with the AF moving part (200). The AF coil (420) may be disposed in the AF moving part (200). The AF coil (420) may be fixed to the AF moving part (200). The AF coil (420) may be coupled to the AF moving part (200). At this time, the AF magnet (410) may be disposed in the fixed part (100).

The lens driving device (10) may comprise an AF sensor (430). The AF driving part (400) may comprise an AF sensor (430). The AF sensor (430) may be a Hall sensor. The AF sensor (430) may be disposed on the AF substrate (710). The AF sensor (430) may detect the AF magnet (410). The AF sensor (430) may detect the movement of the AF magnet (410). The amount of movement or position of the AF magnet (410) detected by the AF sensor (430) may be used for feedback for autofocus drive.

The AF sensor (430) may be a driver IC. The driver IC may comprise a sensing part. The sensing part may comprise a Hall element (Hall IC). The driver IC may be electrically connected to the AF coil (420). The driver IC may supply current to the AF coil (420).

The AF sensor (430) may overlap with a neutral part of the AF magnet (410) in a direction perpendicular to the optical axis. The AF sensor (430) may overlap with the AF coil (420) in the optical axis direction. The AF sensor (430) may overlap with the AF coil (420) in a direction perpendicular to the optical axis. The AF sensor (430) may be disposed within the AF coil (420). As a modified example or a variant, the AF sensor (430) may be disposed on the outer side of the AF coil (420).

The lens driving device (10) may comprise an OIS driving part. The OIS driving part may move the OIS moving part (300) in a direction perpendicular to the optical axis. The OIS driving part may move the OIS carrier (310) in a direction perpendicular to the optical axis. The OIS driving part may move the OIS carrier (310) in a direction perpendicular to the optical axis through electromagnetic force. The OIS driving part may move the OIS carrier (310) in a direction perpendicular to the optical axis relative to the AF carrier (210).

The lens driving device (10) may comprise an OIS-x driving part (500). The OIS driving part may comprise an OIS-x driving part (500). The OIS-x driving part (500) may move the OIS carrier (310) in the x-axis direction perpendicular to the optical axis. The OIS-x driving part (500) may move the OIS carrier (310) in the x-axis direction perpendicular to the optical axis relative to the AF carrier (210). The OIS-x driving part (500) may move the OIS carrier (310) in the x-axis direction perpendicular to the optical axis using electromagnetic force. The OIS-x driving part (500) may comprise a coil and a magnet.

In this embodiment, the OIS-x magnet (510) and the OIS-x coil (520) may move the OIS moving part (300) in a first direction perpendicular to the optical axis. At this time, the first direction may be the x-axis direction. Due to the interaction between the OIS-x coil (520) and the OIS-x magnet (510), the OIS carrier (310) may move in the x-axis direction perpendicular to the optical axis. The OIS-x magnet (510) and the OIS carrier (310) may move together in the x-axis direction.

The lens driving device (10) may comprise the OIS-x magnet (510). The OIS driving part may comprise the OIS-x magnet (510). The OIS-x magnet (510) may be an “OIS-x magnet”. The OIS-x magnet (510) may be a permanent magnet. The OIS-x magnet (510) may be disposed in the OIS moving part (300). The OIS-x magnet (510) may be spaced apart from the AF magnet (410). The OIS-x magnet (510) may be disposed on the OIS carrier (310). The OIS-x magnet (510) may be disposed on the outer surface of the OIS carrier (310). The OIS-x magnet (510) may be fixed to the OIS carrier (310). The OIS-x magnet (510) may be coupled to the OIS carrier (310). The OIS-x magnet (510) may be adhered to the OIS carrier (310) with an adhesive. The OIS-x magnet (510) may be disposed within the cover (120). The OIS-x magnet (510) may interact with the OIS-x coil (520). The OIS-x magnet (510) may electromagnetically interact with the OIS-x coil (520). The OIS-x magnet (510) may be disposed at a corresponding location relative to the OIS-x coil (520). The OIS-x magnet (510) may face the OIS-x coil (520). The OIS-x magnet (510) may be oriented opposite the OIS-x coil (520). The OIS-x magnet (510) may be overlapped with the OIS-x coil (520) in a direction perpendicular to the optical axis. The OIS-x magnet (510) may be overlapped with the OIS-x coil (520) in the x-axis direction. The OIS-x magnet (510) may move in the x-axis direction perpendicular to the optical axis.

The OIS-x magnet (510) may be a 2-pole magnet. The OIS-x magnet (510) may comprise a 2-pole magnet. The OIS-x magnet (510) may comprise an N-pole and an S-pole.

The lens driving device (10) may comprise an OIS-x coil (520). The OIS driving part may comprise an OIS-x coil (520). The OIS-x coil (520) may be disposed in the AF moving part (200). The OIS-x coil (520) may be disposed in the OIS substrate (720). The OIS-x coil (520) may be disposed in the AF carrier (210). The OIS-x coil (520) may be disposed on the holder member (220). The OIS-x coil (520) may interact with the OIS-x magnet (510). The OIS-x coil (520) may move the OIS-x magnet (510) in the x-axis direction perpendicular to the optical axis. The OIS-x coil (520) may move the OIS-x magnet (510) in the x-axis direction through interaction with the OIS-x magnet (510). The OIS-x coil (520) may face the OIS-x magnet (510). The OIS-x coil (520) may face the OIS-x magnet (510). The OIS-x coil (520) may be disposed at a corresponding location relative to the OIS-x magnet (510). The OIS-x coil (520) may overlap with the OIS-x magnet (510) in the x-axis direction.

In this embodiment, the OIS-x coil (520) may move together with the AF moving part (200). The OIS-x coil (520) may move in the optical axis direction together with the AF moving part (200). During the AF drive process, the OIS-x coil (520) may move in the optical axis direction together with the AF moving part (200). The OIS-x coil (520) may be disposed on the AF moving part (200). The OIS-x coil (520) may be fixed to the AF moving part (200). The OIS-x coil (520) may be coupled to the AF moving part (200).

The lens driving device (10) may comprise an OIS-x sensor (530). The OIS driving part may comprise the OIS-x sensor (530). The OIS-x sensor (530) may be disposed on the OIS substrate (720). The OIS-x sensor (530) may comprise a Hall sensor. The OIS-x sensor (530) may detect the OIS-x magnet (510). The OIS-x sensor (530) can detect the magnetic force of the OIS-x magnet (510). The OIS-x sensor (530) may be disposed below the OIS-x magnet (510). The OIS-x sensor (530) may overlap with the OIS-x magnet (510) in the optical axis direction. As a modified example or an alternative example, the OIS-x sensor (530) may be disposed within the OIS-x coil (520). The OIS-x sensor (530) may be aligned with the optical axis of the OIS-x coil (520). The OIS-x sensor (530) may be overlapped with the OIS-x coil (520) in a direction perpendicular to the optical axis. The OIS-x sensor (530) may be opposed to the OIS-x magnet (510). The OIS-x sensor (530) may be disposed at a location corresponding to that of the OIS-x magnet (510). The OIS-x sensor (530) can detect the movement of the OIS-x magnet (510). The amount of movement or position of the OIS-x magnet (510) detected by the OIS-x sensor (530) may be used as feedback for the x-axis direction image stabilization (hand shake correction) drive.

The lens driving device (10) may comprise an OIS-y driving part (600). The OIS driving part may comprise an OIS-y driving part (600). The OIS-y driving part (600) may move the OIS carrier (310) in the y-axis direction perpendicular to both the optical axis and the x-axis direction. The OIS-y driving part (600) may move the OIS carrier (310) in the y-axis direction perpendicular to both the optical axis and the x-axis direction relative to the AF carrier (210). The OIS-y driving part (600) may move the OIS carrier (310) in the y-axis direction perpendicular to both the optical axis and the x-axis direction through electromagnetic force. The OIS-y driving part (600) may comprise a coil and a magnet.

In this embodiment, the OIS-y magnet (610) and the OIS-y coil (620) may move the OIS moving part (300) in a second direction perpendicular to the optical axis direction and the first direction. At this time, the second direction may be the y-axis direction. Due to the interaction between the OIS-y coil (620) and the OIS-y magnet (610), the OIS carrier (310) may move in the y-axis direction, which is perpendicular to both the optical axis direction and the x-axis direction. The OIS-y magnet (610) and the OIS carrier (310) may move together in the y-axis direction. The OIS-y magnet (610) may overlap with the AF magnet (410) in the second direction. The OIS-y magnet (610) may overlap with the AF magnet (410) in the y-axis direction.

The lens driving device (10) may comprise an OIS-y magnet (610). The OIS-y driving part (600) may comprise an OIS-y magnet (610). The OIS-y magnet (610) may be an “OIS-y magnet”. The OIS-y magnet (610) may be a permanent magnet. The OIS-y magnet (610) may be disposed in the OIS moving part (300). The OIS-y magnet (610) may be spaced apart from the OIS-x magnet (510). The OIS-y magnet (610) may be spaced apart from the AF magnet (410). The OIS-y magnet (610) may be disposed on the OIS carrier (310). The OIS-y magnet (610) may be disposed on the outer (side) surface of the OIS carrier (310). The OIS-y magnet (610) may be fixed to the OIS carrier (310). The OIS-y magnet (610) may be coupled to the OIS carrier (310). The OIS-y magnet (610) may be adhered to the OIS carrier (310) with an adhesive. The OIS-y magnet (610) may be disposed within the cover (120). The OIS-y magnet (610) may interact with the OIS-y coil (620). The OIS-y magnet (610) may electromagnetically interact with the OIS-y coil (620). The OIS-y magnet (610) may be disposed at a corresponding location relative to the OIS-y coil (620). The OIS-y magnet (610) may face the OIS-y coil (620). The OIS-y magnet (610) may be oriented opposite the OIS-y coil (620). The OIS-y magnet (610) may be overlapped with the OIS-y coil (620) in a direction perpendicular to the optical axis. The OIS-y magnet (610) may be overlapped with the OIS-y coil (620) in the y-axis direction. The OIS-y magnet (610) may move in the y-axis direction.

The OIS-y magnet (610) may be a two-pole magnet. The OIS-y magnet (610) may comprise a two-pole magnetized magnet. The OIS-y magnet (610) may comprise an N pole and an S pole.

The lens driving device (10) may comprise an OIS-y coil (620). The OIS-y driving part (600) may comprise an OIS-y coil (620). The OIS-y coil (620) may be disposed in the AF moving part (200). The OIS-y coil (620) may be disposed in the OIS substrate (720). The OIS-y coil (620) may be disposed in the AF carrier (210). The OIS-y coil (620) may be disposed on the holder member (220). The OIS-y coil (620) may interact with the OIS-y magnet (610). The OIS-y coil (620) may be disposed on the opposite side of the AF coil (420) relative to the optical axis. The OIS-y coil (620) may move the OIS-y magnet (610) in the y-axis direction perpendicular to both the optical axis and the x-axis. The OIS-y coil (620) may move the OIS-y magnet (610) in the y-axis direction through interaction with the OIS-y magnet (610). The OIS-y coil (620) may be disposed opposite the OIS-y magnet (610). The OIS-y coil (620) may face the OIS-y magnet (610). The OIS-y coil (620) may be disposed at a location corresponding to that of the OIS-y magnet (610). The OIS-y coil (620) may overlap with the OIS-y magnet (610) in a direction perpendicular to the optical axis.

In the present embodiment, the OIS-y coil (620) may move together with the AF moving part (200). The OIS-y coil (620) may move in the optical axis direction together with the AF moving part (200). During the AF drive process, the OIS-y coil (620) may move in the optical axis direction together with the AF moving part (200). The OIS-y coil (620) may be disposed in the AF moving part (200). The OIS-y coil (620) may be fixed to the AF moving part (200). The OIS-y coil (620) may be coupled to the AF moving part (200).

The lens driving device (10) may comprise an OIS-y sensor (630). The OIS-y driving part (600) may comprise an OIS-y sensor (630). The OIS-y sensor (630) may be disposed on the OIS substrate (720). The OIS-y sensor (630) may comprise a Hall sensor. The OIS-y sensor (630) may detect the OIS-y magnet (610). The OIS-y sensor (630) may detect the magnetic force of the OIS-y magnet (610). The OIS-y sensor (630) may be disposed below the OIS-y magnet (610). The OIS-y sensor (630) may be aligned with the optical axis of the OIS-y magnet (610). The OIS-y sensor (630) may be aligned with the OIS-y magnet (610) in a direction perpendicular to the optical axis. As a modified example or an alternative, the OIS-y sensor (630) may be disposed inside the OIS-y coil (620). The OIS-y sensor (630) may be overlapped with the OIS-y coil (620) in the optical axis direction. The OIS-y sensor (630) may be opposed to the OIS-y magnet (610). The OIS-y sensor (630) may be disposed at a corresponding location relative to the OIS-y magnet (610). The OIS-y sensor (630) can detect the movement of the OIS-y magnet (610). The amount or position of the OIS-y magnet (610) detected by the OIS-y sensor (630) may be used as feedback for y-axis direction image stabilization (handshake correction) drive.

When viewed from above, the AF coil (420), AF magnet (410), OIS-y magnet (610) and OIS-y coil (620) may be disposed in order on a virtual straight line. When viewed from the top, the AF coil (420), AF magnet (410), OIS-y magnet (610), and OIS-y coil (620) may be disposed in order along an imaginary straight line. When viewed from above, the AF coil (420), AF magnet (410), OIS-y magnet (610), and OIS-y coil (620) may be disposed in order. When viewed from above, the AF coil (420), AF magnet (410), OIS-y magnet (610), and OIS-y coil (620) may be disposed in order along the y-axis. When viewed from above, the AF coil (420), AF magnet (410), OIS-y magnet (610), and OIS-y coil (620) may overlap in the y-axis direction.

The lens driving device (10) may comprise a substrate (710, 720). The substrate (710, 720) may comprise a flexible printed circuit board (FPCB). The substrate (710, 720) may be electrically connected to the coils (420, 520, 620). The substrate (710, 720) may be electrically connected to the sensors (430, 530, 630).

The lens driving device (10) may comprise an AF substrate (710). The AF substrate (710) may be disposed on the fixed part (100). The AF substrate (710) may be disposed on the base (110). The AF substrate (710) may be disposed on the cover (120). The AF board (710) may be disposed on a side (lateral) plate (122) of the cover (120). The AF substrate (710) may be electrically connected to the AF coil (420). The AF substrate (710) may be electrically connected to the AF sensor (430). The AF substrate (710) may comprise a terminal part (711). The terminal part (711) may be formed at a lower end of the AF substrate (710). The AF substrate (710) may comprise a plurality of terminals. The multiple terminals of the AF substrate (710) may be coupled to the printed circuit board (50). The multiple terminals of the AF substrate (710) may be electrically connected to the terminals of the printed circuit board (50).

The lens driving device (10) may comprise an OIS substrate (720). The OIS substrate (720) may be electrically connected to the OIS coils (520, 620). The OIS substrate (720) may be electrically connected to the OIS sensors (530, 630). A portion of the OIS substrate (720) may be disposed on the AF moving part (200). A portion of the OIS substrate (720) may be disposed on the AF carrier (210). A portion of the OIS substrate (720) may be fixed to the AF carrier (210). A portion of the OIS substrate (720) may be coupled to the AF carrier (210). A portion of the OIS substrate (720) may be adhesively bonded to the AF carrier (210) using an adhesive. Another portion of the OIS substrate (720) may be disposed on the fixed member (100). The OIS substrate (720) may connect the fixed member (100) and the AF moving part (200).

The OIS substrate (720) may elastically connect the fixed part (100) and the AF moving part (200). The OIS substrate (720) may support the AF moving part (200) so that it can move relative to the fixed part (100). The OIS substrate (720) may comprise a flexible substrate. The OIS substrate (720) may comprise a flexible printed circuit board (FPCB). The OIS substrate (720) may comprise a portion having elasticity. The OIS substrate (720) may comprise an elastic member.

The OIS substrate (720) may comprise an inner part (721). The inner part (721) may be disposed on the AF moving part (200). The inner part (721) may be disposed on the AF carrier (210). The inner part (721) may be disposed on the holder member (220).

The OIS substrate (720) may comprise a lower plate part (721-1). The lower plate part (721-1) may be disposed on the lower surface of the AF carrier (210). The lower plate part (721-1) may be disposed on the lower surface of the holder member (220). The lower plate part (721-1) may comprise an OIS-x sensor (530). The lower plate part (721-1) may comprise an OIS-y sensor (630).

The OIS board (720) may comprise a side (lateral) plate part (721-2). The side plate part (721-2) may be disposed on the side surface of the AF carrier (210). The side plate part (721-2) may be disposed on the side surface of the holder member (220). The side plate part (721-2) may extend upward from the lower plate part (721-1). The side plate part (721-2) may be bent and extended from the outer edge of the lower plate part (721-1). The side plate part (721-2) may comprise a first portion where the OIS-x coil (520) is disposed. The side plate part (721-2) may comprise a second portion where the OIS-y coil (620) is disposed.

The OIS substrate (720) may comprise an outer part (722). The outer part (722) may be disposed on the fixed part (100). The outer part (722) may be disposed on the base (110). The outer part (722) may be disposed on the cover (120). The outer part (722) may be disposed on the side plate (122) of the cover (120). The outer part (722) may comprise a terminal part formed at the lower end. The outer part (722) may comprise multiple terminals. The multiple terminals of the outer part (722) may be coupled to the printed circuit board (50). The multiple terminals of the outer part (722) may be electrically connected to the terminals of the printed circuit board (50).

The OIS substrate (720) may comprise a connecting (connection) part (723). The connecting part (723) may be disposed between the inner part (721) and the outer part (722). The connecting part (723) may connect the inner part (721) and the outer part (722). The connecting part (723) may elastically connect the inner part (721) and the outer part (722). The connecting part (723) may have elasticity. The connecting part (723) may comprise an elastic member. The connecting part (723) may be a flexible member. The connecting part (723) may comprise a shape that is folded multiple times. The connecting part (723) may comprise a shape that is folded at least twice. The connecting part (723) may comprise a first bent portion and a second bent portion. The connecting part (723) may comprise a first portion, a second portion disposed on the first portion, and a third portion disposed on the second portion. In this case, the first bent portion may connect the first portion and the second portion, and the second bent portion may connect the second portion and the third portion. The first to third portions may overlap in the optical axis direction.

The lens driving device (10) may comprise an AF guide ball (810). The AF guide ball (810) may guide the movement of the AF moving part (200) relative to the fixed part (100) in the optical axis direction. The AF guide ball (810) can guide the movement of the AF carrier (210) relative to the base (110) in the optical axis direction. The AF guide ball (810) may be disposed between the fixed part (100) and the AF moving part (200). The AF guide ball (810) may be disposed between the base (110) and the AF carrier (210). The AF guide ball (810) may be disposed between the base (110) and the AF carrier (210) in the x-direction. Alternatively, the AF guide ball (810) may be disposed between the base (110) and the AF carrier (210) in the y-direction. The AF guide ball (810) may be disposed in a groove of the base (110). The AF guide ball (810) may be disposed in a groove of the AF carrier (210). The AF guide ball (810) may be spherical in shape. The AF guide ball (810) may be formed from metal. The surface of the AF guide ball (810) may be coated with grease.

The AF guide ball (810) may be disposed at the first corner of the base (110). The AF guide ball (810) may be disposed at the third corner of the base (110), not at the second corner diagonally opposite the first corner. The AF guide ball (810) may be disposed at each of the first corner and third corner of the base (110). The AF guide ball (810) may be disposed in the first corner area and third corner area of the fixed part (100). The AF guide balls (810) may be disposed in two sets at each of the first corner and third corner of the base (110). In this case, one set may comprise three balls. Alternatively, one set may comprise four balls. The two sets may be disposed on opposite sides of the column part of the AF carrier (210).

When viewed from above, the AF guide ball (810) may comprise the first unit ball and the second unit ball disposed in the first corner area of the fixed body (100) and the third unit ball and the fourth unit ball disposed in the third corner area of the fixed body (100). The AF guide ball (810) may be disposed two sets per corner.

The AF guide ball (810) may comprise a ball that overlaps with the OIS guide ball in a direction perpendicular to the optical axis. At least a portion of the AF guide ball (810) may overlap with the OIS guide ball.

The AF guide ball (810) may comprise an inner ball (811). The inner ball (811) may be disposed on the column part (111) of the base (110). The inner ball (811) may be disposed in the inner groove (111-1) of the base (110). The inner ball (811) may be disposed in the inner groove (224-1) of the AF carrier (210). The inner ball (811) may be disposed in the inner groove (224-1) of the AF moving part (200). The inner ball (811) may be disposed in both the inner groove (111-1) of the base (110) and the inner groove (224-1) of the AF carrier (210). The inner ball (811) may be disposed between the inner groove (111-1) of the base (110) and the inner groove (224-1) of the AF carrier (210). The inner ball (811) may be disposed between the AF moving part (200) and the column part (111) of the fixed part (100).

The AF guide ball (810) may comprise an outer ball (812). The outer ball (812) may be disposed on the outer wall part (112) of the base (110). The outer ball (812) may be disposed in the outer groove (112-1) of the base (110). The outer ball (812) may be disposed in the outer groove (224-2) of the AF carrier (210). The outer ball (812) may be disposed in both the outer groove (112-1) of the base (110) and the outer groove (224-2) of the AF carrier (210). The outer ball (812) may be disposed between the outer groove (112-1) of the base (110) and the outer groove (224-2) of the AF carrier (210). The outer ball (812) may be disposed between the outer groove (112-1) of the fixed part (100) and the outer groove (224-2) of the AF moving part (200). The outer ball (812) may be disposed between the outer wall part (112) of the fixed part (100) and the AF moving part (200).

The inner ball (811) may comprise a plurality of inner balls (811). The plurality of inner balls (811) may be disposed in the optical axis direction. The inner ball (811) may comprise three inner balls (811). The inner ball (811) may comprise a first to third inner ball. Among the three inner balls (811), two may have a larger diameter and the remaining one may have a smaller diameter. The two balls with larger diameters may be disposed at the uppermost area and at the lowermost area. That is, one ball with the smaller diameter may be disposed between the two balls with larger diameters. Alternatively, the inner ball (811) may comprise four inner balls (811). The inner ball (811) may comprise the first to fourth inner balls. Among the four inner balls (811), two may have a larger diameter and the remaining two may have a smaller diameter. The two balls with the larger diameter may be disposed at the uppermost area and at a lowermost area. That is, the two balls with the smaller diameter may be disposed between the two balls with the larger diameter.

The inner ball (811) may comprise the inner uppermost ball (811-1). The inner uppermost ball (811-1) may be disposed highest among the inner balls (811). The innermost upper ball (811-1) may be disposed closest to the upper plate (121) of the cover (120) among the inner balls (811). The inner ball (811) may comprise the inner lowermost ball (811-2). The inner lowermost ball (811-2) may be disposed at the lowest point among the inner balls (811). The inner lowermost ball (811-2) may be disposed closest to the lower plate part of the base (110) among the inner balls (811). Multiple inner balls (811) may comprise balls with a smaller diameter than the inner uppermost ball (811-1) and the inner lowermost ball (811-2). Multiple inner balls (811) may comprise balls disposed between the inner uppermost ball (811-1) and the inner lowermost lower ball (811-2).

The outer ball (812) may comprise a plurality of outer balls (812). The plurality of outer balls (812) may be disposed in the optical axis direction. The outer ball (812) may comprise three outer balls (812). The outer ball (812) may comprise the first to third outer balls. Among the four outer balls (812), two may have a larger diameter, and the remaining one may have a smaller diameter. The two balls with larger diameters may be disposed at the uppermost area and at the lowermost area. That is, the ball with the smaller diameter may be disposed between the two balls with larger diameters. Alternatively, the outer ball (812) may comprise four outer balls (812). The outer ball (812) may comprise the first to fourth outer balls. Among the four outer balls (812), two may have a larger diameter and the remaining two may have a smaller diameter. The two balls with the larger diameter may be disposed at the uppermost area and at the lowermost area. That is, the two balls with the smaller diameter may be disposed between the two balls with the larger diameter.

The outer ball (812) may comprise the outer uppermost ball (812-1). The outer uppermost ball (812-1) may be disposed highest among the outer balls (812). The outer uppermost ball (812-1) may be disposed closest to the upper plate (121) of the cover (120) among the outer balls (812). The outer ball (812) may comprise the outer lowermost ball (812-2). The outer lowermost ball (812-2) may be disposed lowest among the outer balls (812). The outer lowermost ball (812-2) may be disposed closest to the lower plate part of the base (110) among the outer balls (812). Multiple outer balls (812) may comprise balls with a smaller diameter than each of the outer uppermost ball (812-1) and the outer lowermost ball (812-2). Multiple outer balls (812) may comprise balls disposed between the outer uppermost ball (812-1) and the outer lowermost ball (812-2).

The lens driving device (10) may comprise an OIS guide ball. The OIS guide ball may guide the movement of the AF carrier (210) relative to the OIS carrier (310) in a direction perpendicular to the optical axis. The OIS guide ball may be disposed between the AF moving part (200) and the OIS moving part (300). The OIS guide ball may be disposed between the AF carrier (210) and the OIS carrier (310). The OIS guide ball may be disposed between the AF carrier (210) and the OIS carrier (310) in the optical axis direction. The OIS guide ball may be disposed between the lower plate of the AF carrier (210) and the OIS carrier (310). The OIS guide ball may be disposed between the lower plate (221) of the holder member (220) and the OIS carrier (310).

The lens driving device (10) may comprise an OIS-x guide ball (821). The OIS guide ball may comprise the OIS-x guide ball (821). The OIS-x guide ball (821) may be disposed between the lower plate of the AF carrier (210) and the guide member (350). The OIS-x guide ball (821) may be disposed between the lower plate (221) of the holder member (220) and the guide member (350). In the optical axis direction, the OIS-x guide ball (821) may be disposed between the lower plate of the AF carrier (210) and the guide member (350). In the optical axis direction, the OIS-x guide ball (821) may be disposed between the lower plate (221) of the holder member (220) and the guide member (350).

The OIS-x guide ball (821) may be disposed between the groove (222) of the AF carrier (210) and the groove (351) of the guide member (350). The OIS-x guide ball (821) may come into direct contact with the AF carrier (210) and the guide member (350). In this case, even if grease is applied to the OIS-x guide ball (821) and some of it causes separation, it can still be considered to be in direct contact. The OIS-x guide ball (821) can connect the AF carrier (210) and the guide member (350).

The guide member (350) may be guided to move in the x-axis direction by the OIS-x guide ball (821). At this time, the OIS carrier (310) may move in the x-axis direction together with the guide member (350).

The lens driving device (10) may comprise an OIS-y guide ball (822). The OIS guide ball may comprise the OIS-y guide ball (822). The OIS-y guide ball (822) may be disposed between the guide member (350) and the OIS carrier (310). In the optical axis direction, the OIS-y guide ball (822) may be disposed between the guide member (350) and the OIS carrier (310).

The OIS-y guide ball (822) may be disposed between the groove (352) of the guide member (350) and the groove (311) of the OIS carrier (310). The OIS-y guide ball (822) may come into direct contact with the guide member (350) and the OIS carrier (310). In this case, even if grease is applied to the OIS-y guide ball (822) and some of it causes a slight separation, it can still be considered to be in direct contact. The OIS-y guide ball (822) may connect the guide member (350) and the OIS carrier (310).

The OIS carrier (310) may be guided to move in the y-axis direction by the OIS-y guide ball (822). At this time, the guide member (350) does not move together, and only the OIS carrier (310) may move.

The OIS-x guide ball (821) may be guided to move in the x-axis direction. The OIS-y guide ball (822) may be guided to move in the y-axis direction. However, the OIS-x guide ball (821) and the OIS-y guide ball (822) may be so disposed as to swap positions. In this embodiment, the OIS-y guide ball (822) is disposed higher than the OIS-x guide ball (821), but in a modified example or embodiment, the OIS-y guide ball (822) may be disposed lower than the OIS-x guide ball (821). In other words, in the modified example, the OIS-y guide ball (822) may be disposed between the lower plate of the AF carrier (210) and the guide member (350), and the OIS-x guide ball (821) may be disposed between the guide member (350) and the OIS carrier (310).

One of the OIS-x guide balls (821) and OIS-y guide balls (822) may be guided to move in the x-axis direction, and the other may be guided to move in the y-axis direction. In other words, the OIS-x guide ball (821) and OIS-y guide ball (822) may be guided to move in different directions. The OIS-x guide ball (821) and the OIS-y guide ball (822) may be guided to move in mutually orthogonal directions.

The lens driving device (10) may comprise a pressing member. The pressing member may be a pressing part. The pressing member may comprise an OIS guide ball pressing member. The OIS guide ball pressing member may press the OIS guide ball. The OIS guide ball pressing member may press the OIS-x guide ball (821). The OIS guide ball pressing member may press the OIS-y guide ball (822). The OIS guide ball pressing member may be formed to press the OIS guide ball. The OIS guide ball pressed by the OIS guide ball pressing member may be sandwiched between the AF moving part (200) and the OIS moving part (300). The OIS guide ball pressing member may maintain the OIS guide ball in contact with the AF moving part (200) and the OIS moving part (300).

The lens driving device (10) may comprise a pressing ball (830). The OIS guide ball pressing member may comprise a pressing ball (830). The pressing ball (830) may be disposed between the upper plates of the OIS carrier (310) and the AF carrier (210). The pressing ball (830) may be disposed between the OIS carrier (310) and the cover (230). In the optical axis direction, the pressure ball (830) may be disposed between the upper surfaces of the OIS carrier (310) and the AF carrier (210). In the optical axis direction, the pressing ball (830) may be disposed between the OIS carrier (310) and the cover (230). The pressing ball (830) may be disposed on the upper surface of the OIS carrier (310). In this case, the OIS guide ball may be disposed on the lower surface of the OIS carrier (310). That is, the pressing ball (830) may be disposed on the opposite side of the OIS guide ball relative to the OIS carrier (310).

The lens driving device (10) may comprise an elastic member (840). The OIS guide ball pressing member may comprise an elastic member (840). The elastic member (840) may be disposed between the pressing ball (830) and the upper plate of the AF carrier (210). The elastic member (840) may be disposed between the pressing ball (830) and the cover (230). In the optical axis direction, the elastic member (840) may be disposed between the pressing ball (830) and the upper surface of the AF carrier (210). In the optical axis direction, the elastic member (840) may be disposed between the pressing ball (830) and the cover (230).

The elastic member (840) may press the pressing ball (830) in the direction in which the upper plate of the AF carrier (210) faces the OIS carrier (310). The elastic member (840) may press the pressing ball (830). The elastic member (840) can press the pressing ball (830) downward. The elastic member (840) may press the pressing ball (830) in the optical axis direction. The elastic member (840) may press the pressing ball (830) toward the OIS carrier (310). The elastic member (840) may press the pressing ball (830) in the direction in which the cover (230) faces the OIS carrier (310). The elastic member (840) can press the pressing ball (830) so that it is in close contact with the AF carrier (210).

The OIS carrier (310) can press the OIS guide ball toward the lower plate side of the AF carrier (210) by the pressing force of the elastic member (840). The OIS carrier (310) can press the OIS-x guide ball (821) toward the lower plate side of the AF carrier (210) due to the pressure force of the elastic member (840). Under the pressure of the elastic member (840), the OIS carrier (310) can press the OIS-y guide ball (822) toward the lower plate side of the AF carrier (210). Under the pressure of the elastic member (840), the OIS carrier (310) can press the OIS guide ball toward the lower plate (221) side of the holder member (220) of the AF carrier (210).

The elastic member (840) may comprise first to third portions (841, 842, 843). The elastic member (840) may comprise a first portion (841) and a second portion (842) disposed on the upper plate of the AF carrier (210), and a third portion (843) connecting the first portion (841) and the second portion (842) and disposed on the plate member (850).

As a modified example, the elastic member (840) may comprise a first portion (841) and a second portion (842) disposed on the plate member (850), and a third portion (843) connecting the first portion (841) and the second portion (842) and disposed on the upper plate of the AF carrier (210). The elastic member (840) may comprise a bent part. The first to third portions (841, 842, 843) may be bent parts. The bent part may comprise a bent shape. The bent part may comprise multiple bent parts. The bent part may comprise three bent parts. The elastic member (840) may be bent at least three times. Through this structure, the elastic member (840) may push the plate member (850) away from the cover (230).

The elastic member (840) may be a spring. The elastic member (840) may be a tapered spring. The elastic member (840) may be disposed in the AF moving part (200). The elastic member (840) may be disposed in the cover (230). The elastic member (840) may press the pressing ball (830) toward the OIS moving part (300). The elastic member (840) may press the plate member (850) toward the pressing ball (830). The elastic member (840) may be disposed between the plate member (850) and the cover (230). The elastic member (840) can push the plate member (850) away from the AF moving part (200). The elastic member (840) can press the plate member (850) in the opposite direction of the cover (230).

As a modified example, the elastic member (840) may be disposed on the OIS moving part (300). In this case, the elastic member (840) may press the pressing ball (830) toward the cover (230). The elastic member (840) may be disposed on either the OIS moving part (300) or the cover (230) and may press the pressing ball (830) toward the other of the OIS moving part (300) and the cover (230).

The lens driving device (10) may comprise a plate member (850). The OIS guide ball pressing member may comprise the plate member (850). The plate member (850) may be disposed between the elastic member (840) and the pressing ball (830). In the optical axis direction, the plate member (850) may be disposed between the elastic member (840) and the pressing ball (830). The plate member (850) may be disposed on the pressing ball (830). The plate member (850) may come into contact with the pressing ball (830). The plate member (850) may be disposed between the elastic member (840) and the pressing ball (830). The plate member (850) may be disposed on the cover (230). The plate member (850) may press the pressing ball (830) toward the OIS carrier (310) by the elastic member (840).

The lens driving device (10) may comprise a pressing member. The pressing member may comprise an AF guide ball pressing member. The AF guide ball pressing member may press the AF guide ball (810). The AF guide ball pressing member may be formed to press the AF guide ball (810). The AF guide ball (810) pressurized by the AF guide ball pressing member may be sandwiched between the fixed part (100) and the AF moving part (200). The AF guide ball (810) pressurized by the AF guide ball pressing member may be sandwiched between the base (110) and the AF carrier (210). The AF guide ball pressing member can maintain the AF guide ball (810) in contact with the fixed part (100) and the AF moving part (200). The AF guide ball pressing member can maintain the AF guide ball (810) in contact with the base (110) and the AF carrier (210).

The lens driving device (10) may comprise a plate member (910). The pressing member may comprise the plate member (910). The plate member (910) may be disposed on the AF guide ball (810). The plate member (910) may come into contact with the AF guide ball (810). The plate member (910) may be disposed on the elastic member (920). The plate member (910) may be disposed on the base (110). The plate member (910) may be disposed between the elastic member (920) and the AF guide ball (810). The plate member (910) may press the AF guide ball (810) toward the AF carrier (210) side by the elastic member (920). The plate member (910) may be disposed between the AF guide ball (810) and the fixed part (100). The plate member (910) may be disposed between the inner ball (811) and the column part (111) of the fixed part (100).

The lens driving device (10) may comprise an elastic member (920). The pressing member may comprise the elastic member (920). The elastic member (920) may be a spring. The elastic member (920) may be a tapered spring. The elastic member (920) may be disposed in the fixed part (100). The elastic member (920) may press the AF guide ball (810) toward the AF moving part (200). The elastic member (920) may press the plate member (910) toward the AF guide ball (810). The elastic member (920) may be disposed between the plate member (910) and the fixed part (100). The elastic member (920) may push the plate member (910) away from the fixed part (100). The elastic member (920) can press the plate member (910) in the opposite direction of the fixed part (100). The elastic member (920) may be disposed between the plate member (910) and the column part (111) of the fixed part (100). The elastic member (920) may be disposed in the inner groove (111-1) of the fixed part (100). The elastic member (920) may press the AF guide ball (810) between the fixed part (100) and the AF moving part (200).

As a modified example, the elastic member (920) may be disposed in the AF moving part (200). In this case, the elastic member (920) may press the AF guide ball (810) toward the fixed part (100). The elastic member (920) may be disposed on either the fixed part (100) or the AF moving part (200) and may press the AF guide ball (810) toward the other one. The elastic member (920) may press the plate member (910). The elastic member (920) may be disposed between the plate member (910) and the base (110). The elastic member (920) may be disposed between the AF guide ball (810) and the base (110). The elastic member (920) may be disposed on the base (110). The elastic member (920) may be disposed in the inner groove (111-1) of the base (110). The elastic member (920) can press the AF guide ball (810) toward the AF carrier (210). Through this, the AF guide ball (810) can maintain contact with the plate member (910) and the AF carrier (210).

The elastic member (920) may comprise a bent part. The bent part may comprise a bent shape. The bent part may comprise a plurality of bent parts. The bent part may comprise three bent parts. The elastic member (920) may be bent at least three times. The elastic member (920) may comprise an upper bent part (921). The elastic member (920) may comprise a lower bent part (922). The elastic member (920) may comprise a connecting bent part (923). The connecting bent part (923) may be disposed between the upper bent part (921) and the lower bent part (922). The upper bent part (921) may form an obtuse angle. The lower bent part (922) may form an obtuse angle. The connecting bent part (923) may form an obtuse angle. The upper bent part (921) may be disposed on the fixed part (100). The lower bent part (922) may be disposed on the fixed part (100). The connecting bent part (923) may be disposed on the plate member (910). Through this structure, the elastic member (920) can push the plate member (910) away from the fixed part (100). The connecting bent part (923) may contact the plate member (910) and apply pressure to the plate member (910) in the direction of the AF guide ball (810).

The lens driving device (10) may comprise a reinforcing member (930). The reinforcing member (930) may be disposed on the base (110). The reinforcing member (930) may be disposed to reinforce the strength of the base (110). The reinforcing member (930) may prevent the base (110) from breaking. The reinforcing member (930) may prevent damage to the column part (111) of the base (110). The reinforcing member (930) may prevent damage to the outer wall part (112) of the base (110). The reinforcing member (930) may have elasticity. The reinforcing member (930) may be formed of metal. The reinforcing member (930) may comprise a shape that is bent at least twice. The reinforcing member (930) may be formed in a “U” shape when viewed from above. The reinforcing member (930) may be open inwardly.

The reinforcing member (930) may comprise an inner part (931). The inner part (931) may be disposed on the opposite side of the inner groove (111-1) of the column part (111) of the fixed part (100). The reinforcing member (930) may comprise an outer part (932). The outer part (932) may be disposed on the opposite side of the outer groove (112-1) of the outer wall part (112) of the fixed part (100). The reinforcing member (930) may comprise a connecting part (933). The connecting part (933) may connect the inner part (931) and the outer part (932).

In the present embodiment, the OIS moving part (300) may be disposed between the lower plate and the upper plate of the AF moving part (200). At this time, the lower plate of the AF moving part (200) may comprise the lower plate (221) of the holder member (220), and the upper plate of the AF moving part (200) may comprise a cover (230).

However, in a modified example, the OIS moving part (300) may be disposed between the lower plate and the upper plate of the fixed part (100). In this case, the lower plate of the fixed part (100) may comprise a base (110), and the upper plate of the fixed part (100) may comprise the upper plate (121) of the cover (120). The OIS ball pressing member may be disposed between the OIS moving part (300) and the upper plate (121) of the cover (120). The elastic member (840) may press the plate member (850) and the pressing ball (830) toward the OIS moving part (300) relative to the upper plate (121) of the cover (120).

The distance between the centers of the two pressing balls (refer to a in FIG. 23b) may be 43 to 63% of the distance between the first portion (841) and the second portion (842) of the elastic member (840) (refer to c in FIG. 23b). The distance between the centers of the two pressing balls (refer to a in FIG. 23b) may be 33 to 73% of the distance between the first portion (841) and the second portion (842) of the elastic member (840) (refer to c in FIG. 23b).

The diameter of one of the two pressing balls may be 83 to 93% of the shortest distance between the two pressing balls (refer to b in FIG. 23b). The diameter of one of the two pressing balls may be 81 to 95% of the shortest distance between the two pressing balls (refer to b in FIG. 23b).

The distance between the upper surface of the plate member (850) and the lower surface of the cover (230) (refer to e in FIG. 23b) may be 80 to 90% of the distance between the upper surface of the OIS carrier (310) and the lower surface of the plate member (850) (refer to d in FIG. 23b). The distance between the upper surface of the plate member (850) and the lower surface of the cover (230) (refer to e in FIG. 23b) may be 77 to 93% of the distance between the upper surface of the OIS carrier (310) and the lower surface of the plate member (850) (refer to d in FIG. 23b).

The following describes the auto focus (AF) drive (operation) of the lens driving device according to an embodiment of the present disclosure with reference to the drawings.

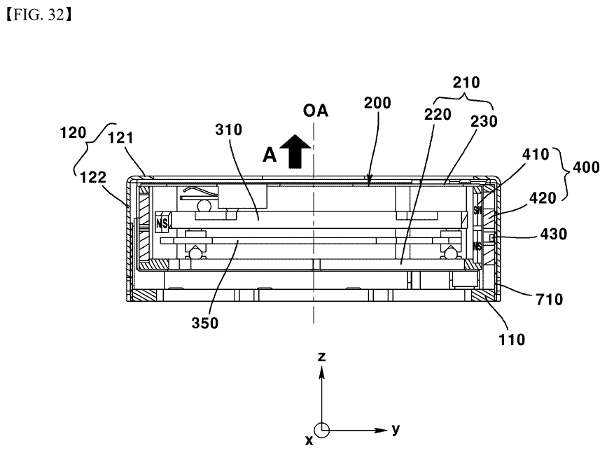

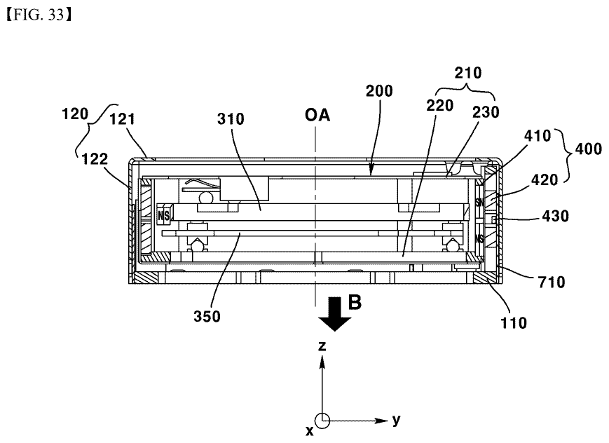

FIGS. 31 to 33 are drawings showing an autofocus drive of a lens driving device according to an embodiment of the present disclosure, where FIG. 31 is a cross-sectional view showing the appearance of a moving part in an initial state where no current is applied to an AF coil, FIG. 32 is a cross-sectional view showing the appearance of the moving part moved upward in the optical axis direction when a forward current is applied to the AF coil, and FIG. 33 is a cross-sectional view showing the moving part moving downward along the optical axis when a reverse current is applied to the AF coil.

As shown in FIG. 31, the moving part may be disposed at a location spaced apart from both the upper plate (121) and the base (110) of the cover (120) when no current is applied to the AF coil (420) at its initial position. At this time, the moving part may be the AF moving part (200). Additionally, the moving part may comprise an AF moving part (200) and an OIS moving part (300).

When a forward current is applied to the AF coil (420), the AF coil (420) moves upward in the optical axis direction due to the electromagnetic interaction between the AF coil (420) and the AF magnet (410) (see FIG. 32A). At this time, the AF carrier (210) may move upward in the optical axis direction along with the AF coil (420). Furthermore, the OIS carrier (310) and the lens may move upward in the optical axis direction along with the AF carrier (210). As a result, the distance between the lens and the image sensor changes, allowing the focus of the image formed on the image sensor through the lens to be adjusted.

When a reverse current is applied to the AF coil (420), the AF coil (420) may move downward along the optical axis due to the electromagnetic interaction between the AF coil (420) and the AF magnet (410) (see FIG. 33B). At this time, the AF carrier (210) may move downward along the optical axis direction together with the AF coil (420). Furthermore, the OIS carrier (310) and the lens may move downward along the optical axis direction together with the AF carrier (210). As a result, the distance between the lens and the image sensor changes, allowing the focus of the image formed on the image sensor through the lens to be adjusted.

Meanwhile, during the movement of the AF coil (420), the AF sensor (430) may move together with the AF coil (420) and detect the strength of the magnetic field of the AF magnet (410) to detect the amount of movement or position of the lens in the optical axis direction. The amount of movement or position of the lens in the optical axis direction detected by the AF sensor (430) may be used for autofocus feedback control.

Hereinafter, the optical image stabilization (OIS) drive (operation) of a lens driving device according to an embodiment will be described with reference to the drawings.

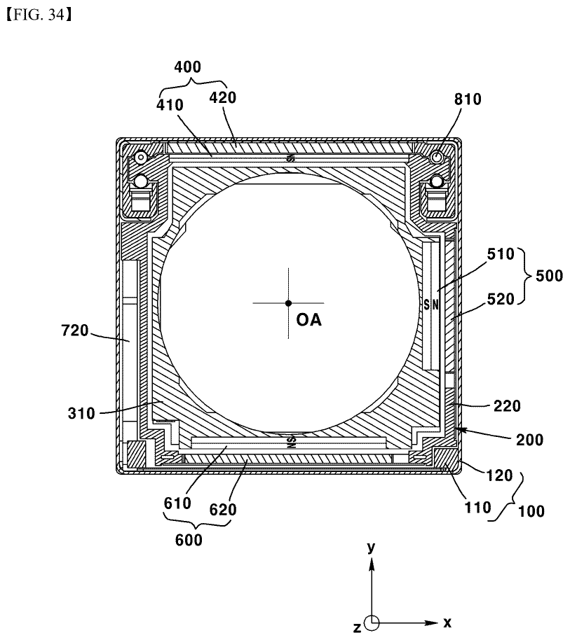

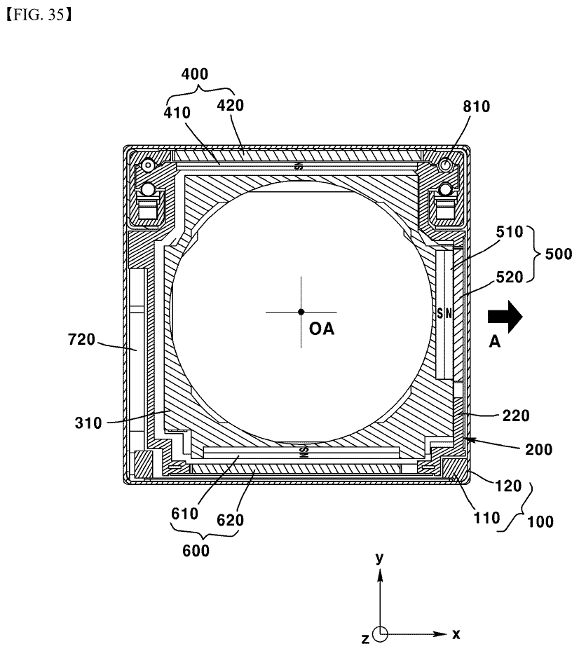

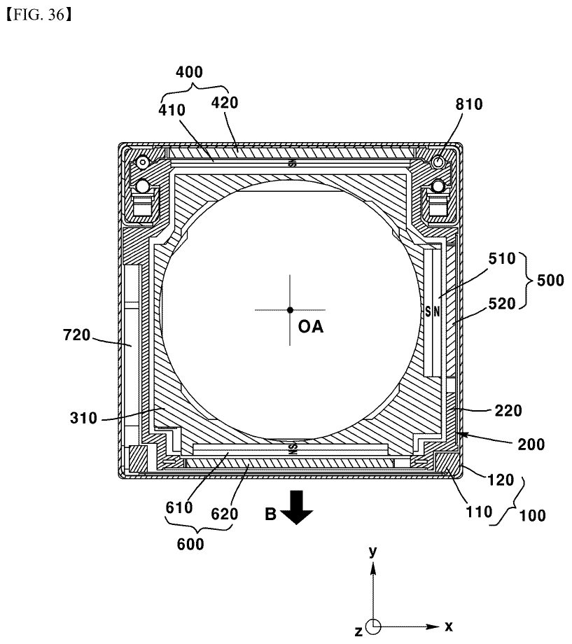

FIGS. 34 to 36 are drawings showing a optical image stabilization drive of a lens driving device according to an embodiment of the present disclosure, where FIG. 34 is a cross-sectional view showing the appearance of an OIS moving part in an initial state where no current is applied to an appearance of an OIS moving part in an initial state where no current is applied to an OIS-x coil and an OIS-y coil, FIG. 35 is a cross-sectional view showing the appearance of an OIS moving part moved in the x-axis direction perpendicular to the optical axis when current is applied to the OIS-x coil, and FIG. 36 is a cross-sectional view showing an OIS moving part moved in the y-axis direction perpendicular to both the optical axis and the x-axis when current is applied to the OIS-y coil.

As shown in FIG. 34, the moving part may be disposed in its initial position without current being applied to the OIS-x coil (520) and the OIS-y coil (620). At this time, the moving part may be the OIS moving part (300).

When current is applied to the OIS-x coil (520), the OIS-x magnet (510) may move in the x-axis direction perpendicular to the optical axis due to the electromagnetic interaction between the OIS-x coil (520) and the OIS-x magnet (510) (see FIG. 35A). At this time, the OIS carrier (310) may move in the x-axis direction along with the OIS-x magnet (510). Furthermore, the lens may move in the x-axis direction along with the OIS carrier (310). More specifically, when a forward current is applied to the OIS-x coil (520), the OIS-x magnet (510), OIS carrier (310), and lens may move in a unidirectional manner along the x-axis. Additionally, when a reverse current is applied to the OIS-x coil (520), the OIS-x magnet (510), OIS carrier (310), and lens may move in the opposite direction along the x-axis.

When current is applied to the OIS-y coil (620), the OIS-y magnet (610) may move in the y-axis direction perpendicular to the optical axis due to the electromagnetic interaction between the OIS-y coil (620) and the OIS-y magnet (610) (see FIG. 36B). At this time, the OIS carrier (310) may move in the y-axis direction along with the OIS-y magnet (610). Furthermore, the lens may move in the y-axis direction along with the OIS carrier (310). More specifically, when a forward current is applied to the OIS-y coil (620), the OIS-y magnet (610), OIS carrier (310), and lens may move in a unidirectional manner along the y-axis. Additionally, when a reverse current is applied to the OIS-y coil (620), the OIS-y magnet (610), OIS carrier (310), and lens may move in the opposite direction along the y-axis.

Meanwhile, the OIS-x sensor (530) may detect the strength of the magnetic field of the OIS-x magnet (510) to detect the displacement or position of the OIS-x magnet (510). The displacement or position detected by the OIS-x sensor (530) may be used for x-axis direction OIS feedback control. The OIS-y sensor (630) may detect the strength of the magnetic field generated by the OIS-y magnet (610) to detect the displacement or position of the OIS-y magnet (610). The displacement or position detected by the OIS-y sensor (630) may be used for y-axis direction OIS feedback control.

The camera device according to the present embodiment will be described below with reference to the drawings.

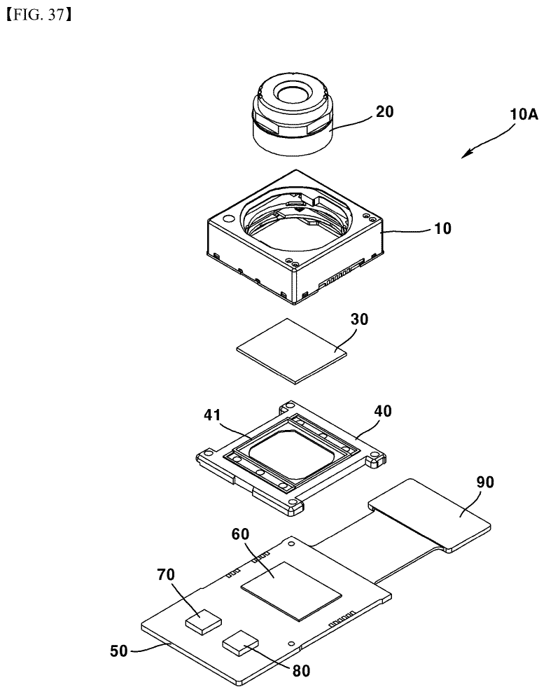

FIG. 37 is an exploded view of the camera device according to the present embodiment.

The camera device (10A) may comprise a camera module.

The camera device (10A) may comprise a lens module (20). The lens module (20) may comprise at least one lens. The lens may be disposed at a location corresponding to the image sensor (60). The lens module (20) may comprise a lens and a barrel. The lens module (20) may be coupled to the OIS carrier (310) of the lens driving device (10). The lens module (20) may be coupled to the OIS carrier (310) by screw coupling and/or adhesive. The lens module (20) may move integrally with the OIS carrier (310).

The camera device (10A) may comprise a filter (30). The filter (30) may serve to block light of a specific frequency band from passing through the lens module (20) and incident onto the image sensor (60). The filter (30) may be arranged parallel to the x-y plane. The filter (30) may be disposed between the lens module (20) and the image sensor (60). The filter (30) may be disposed on the sensor base (40). As an alternative embodiment, the filter (30) may be disposed on the base (110). The filter (30) may comprise an infrared filter. The infrared filter may block light in the infrared region from entering the image sensor (60).

The camera device (10A) may comprise a sensor base (40). The sensor base (40) may be disposed between the lens driving device (10) and the printed circuit board (50). The sensor base (40) may comprise a protruder (41) on which the filter (30) is disposed. An opening may be formed in the portion of the sensor base (40) where the filter (30) is disposed to allow light passing through the filter (30) to enter the image sensor (60). An adhesive member may be used to bond or adhere the base (110) of the lens driving device (10) to the sensor base (40). The adhesive member may further serve to prevent foreign matter from entering the interior of the lens driving device (10). The adhesive member may comprise one or more of epoxy, thermosetting adhesive, and ultraviolet-curable adhesive.

The camera device (10A) may comprise a printed circuit board (PCB) (50). The printed circuit board (PCB) (50) may be a substrate or a circuit board. The lens driving device (10) may be disposed on the printed circuit board (PCB) (50). A sensor base (40) may be disposed between the printed circuit board (PCB) (50) and the lens driving device (10). The printed circuit board (50) may be electrically connected to the lens driving device (10). The printed circuit board (50) may comprise an image sensor (60). The printed circuit board (50) may also comprise various circuits, components, and control units to convert images formed on the image sensor (60) into electrical signals and transmit them to an external device.

The camera device (10A) may comprise an image sensor (60). The image sensor (60) may be configured such that light passing through the lens and filter (30) is incident and an image is formed. The image sensor (60) may be mounted on a printed circuit board (50). The image sensor (60) may be electrically connected to the printed circuit board (50). For example, the image sensor (60) may be bonded to the printed circuit board (50) using surface mounting technology (SMT). In another example, the image sensor (60) may be bonded to the printed circuit board (50) using flip chip technology. The image sensor (60) may be positioned such that its optical axis aligns with the lens's optical axis. That is, the optical axis of the image sensor (60) and the optical axis of the lens may be aligned. The image sensor (60) can convert light incident on the effective image area of the image sensor (60) into an electrical signal. The image sensor (60) may be any one of a CCD (charge-coupled device), MOS (metal-oxide semiconductor), CPD, or CID.

The camera device (10A) may comprise a motion sensor (70). The motion sensor (70) may be mounted on the printed circuit board (50). The motion sensor (70) may be electrically connected to the control unit (80) through circuit patterns provided on the printed circuit board (50). The motion sensor (70) may output rotational angular velocity information based on the movement of the camera device (10A). The motion sensor (70) may comprise a two-axis or three-axis gyro sensor (Gyro Sensor) or an angular velocity sensor.

The camera device (10A) may comprise a control unit (80). The control unit (80) may be disposed on the printed circuit board (50). The control unit (80) may be electrically connected to the coil (330) of the lens driving device (10). The control unit (80) may individually control the direction, magnitude, and amplitude of the current supplied to the coil (330). The control unit (80) can control the lens driving device (10) to perform an auto-focus function and/or an OIS function. Furthermore, the control unit (80) can perform auto-focus feedback control and/or OIS feedback control for the lens driving device (10).

The camera device (10A) may comprise a connector (90). The connector (90) may be electrically connected to the printed circuit board (50). The connector (90) may comprise a port for electrically connecting to an external device.

The following describes the optical instrument according to an embodiment of the present disclosure with reference to the drawings.

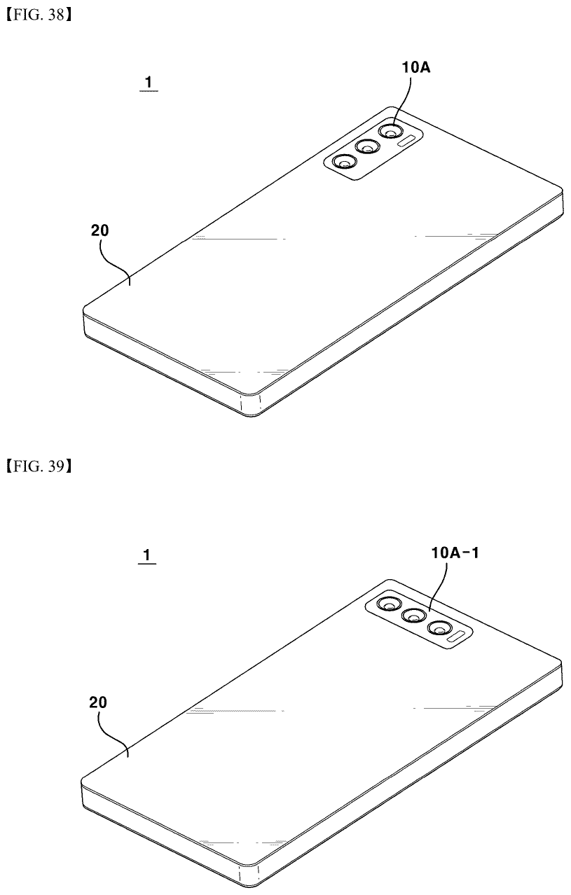

FIG. 38 is a perspective view of the optical instrument according to the embodiment, and FIG. 39 is a perspective view of the optical instrument according to a modified example.

The optical instrument (1) may comprise any one or more of the following: a mobile phone, a smartphone, a smart pad, a digital camera, a laptop computer, a digital broadcasting terminal, a PDA (Personal Digital Assistant), a PMP (Portable Multimedia Player), or a navigation device. Optical device (1) may comprise any device used for capturing images or photographs.

The optical instrument (1) may comprise a main body (20). The optical instrument (1) may comprise a camera device (10A). The camera device (10A) may be disposed in the main body (20). The camera device (10A) may shoot an object. The optical instrument (1) may comprise a display. The display may be disposed on the main body (20). The display may output one or more of the images and videos captured by the camera device (10A). The display may be disposed on the first surface of the main body (20). The camera device (10A) may be disposed on one or more of the first surface and the second surface opposite the first surface of the main body (20). As shown in FIG. 38, the camera device (10A) may comprise a triple camera disposed in a vertical direction. As shown in FIG. 39, the camera device (10A-1) may comprise a triple camera disposed in a horizontal direction.

Although the embodiments of the present disclosure have been described with reference to the accompanying drawings, those skilled in the art will understand that the present disclosure may be embodied in other specific forms without changing the technical concept or essential features thereof. Therefore, the embodiments described above are to be understood as illustrative and not limiting in all respects.

1.-10 (canceled)

11. A camera device, comprising:
a holder member;
a first moving part disposed on the holder member and configured to move in a first direction perpendicular to an optical axis with respect to the holder member;
a second moving part disposed on the first moving part and configured to move in a second direction perpendicular to the optical axis and intersecting the first direction;
a cover disposed on the second moving part and coupled with the holder member;
a first ball disposed between the holder member and the first moving part;
a second ball disposed between the first moving part and the second moving part; and
a pressing part disposed between the second moving part and the cover,
wherein the pressing part comprises an elastic member and is configured to press at least one of the first ball and the second ball.

12. The camera device of claim 11, wherein the pressing part comprises a third ball disposed between the second moving part and the elastic member, and a plate member disposed between the third ball and the elastic member.

13. The camera device of claim 11, wherein the pressing part is configured to press the second moving part toward the holder member in the direction facing downward of the optical axis.

14. The camera device of claim 12, wherein the elastic member comprises a first portion and a second portion disposed on the cover, and a third portion connecting the first portion and the second portion and disposed on the plate member.

15. The camera device of claim 11, comprising:
a first driving part configured to move the first moving part in the first direction relative to the holder member; and
a second driving part configured to move the second moving part in the second direction relative to the holder member.

16. The camera device of claim 15, wherein at least one of the holder member and the first moving part comprises a first groove disposed in the first direction,
wherein the first ball is disposed on a first groove,
wherein at least one of the first moving part and the second moving part comprises a second groove disposed in the second direction, and
wherein the second ball is disposed on a second groove.

17. The camera device of claim 15, comprising a first substrate disposed on the holder member,
wherein the first driving part comprises a first coil disposed on the first substrate and a first magnet disposed on the second moving part and interacting with the first coil, and
wherein the second driving part comprises a second coil disposed on the first substrate and a second magnet disposed on the second moving part and interacting with the second coil.

18. The camera device of claim 11, comprising:
a base; and
a third driving part configured to move the holder member in an optical axis direction relative to the base.

19. The camera device of claim 18, comprising a second substrate disposed on the base,
wherein the third driving part comprises a third coil disposed on the second substrate and a third magnet disposed on the holder member and interacting with the third coil.

20. The camera device of claim 11, wherein the elastic member has a shape bent at least three times.

21. The camera device of claim 12, wherein the elastic member is overlapped with the third ball in an optical axis direction.

22. The camera device of claim 11, wherein the elastic member comprises a tapered spring.

23. The camera device of claim 11, comprising:
a printed circuit board;
an image sensor disposed on the printed circuit board; and
a lens coupled with the second moving part.

24. An optical apparatus, comprising:
a main body;
the camera device of claim 11 disposed on the main body; and
a display disposed on the main body and configured to output one or more of images and videos captured by the camera device.

25. A camera device, comprising:
a base;
an AF carrier disposed on the base;
an OIS carrier disposed on the AF carrier;
a first ball disposed between the AF carrier and a lower surface of the OIS carrier; and
a pressing part disposed on the OIS carrier and comprising an elastic member,
wherein the pressing part is configured to press the first ball against the AF carrier or the OIS carrier so as to be in close contact therewith.

26. The camera device of claim 25, wherein the pressing part comprises a second ball disposed on the OIS carrier and a plate member disposed between the second ball and the elastic member.

27. The camera device of claim 26, wherein the second ball is disposed on an upper surface of the OIS carrier opposite to the lower surface of the OIS carrier.

28. The camera device of claim 25, comprising:
a first coil and a first magnet configured to move the AF carrier in an optical axis direction with respect to the base; and
a second coil and a second magnet configured to move the OIS carrier in a direction perpendicular to the optical axis direction with respect to the AF carrier.

29. The camera device of claim 25, comprising a guide member disposed between the AF carrier and the OIS carrier,
wherein the first ball comprises a first-first ball disposed between the AF carrier and the guide member, and a first-second ball disposed between the guide member and the OIS carrier.

30. A camera device, comprising:
a holder member;
a moving part disposed on the holder member and configured to move in a first direction perpendicular to an optical axis with respect to the holder member;
a cover disposed on the moving part and coupled with the holder member;
a ball disposed between the holder member and the moving part; and
a pressing part disposed between the moving part and the cover,
wherein the pressing part comprises an elastic member and configured to press the ball.
